(19) United States
(12) Patent Application Publication
(10) Pub. No.: US 2025/0360925 A1
(43) Pub. Date: Nov. 27, 2025

(54) AUTOMATED DRIVING CONTROL DEVICE, STORAGE MEDIUM STORING AUTOMATED DRIVING CONTROL PROGRAM, AND AUTOMATED DRIVING CONTROL METHOD

(71) Applicant: DENSO CORPORATION, Kariya-city (JP)

(72) Inventors: Kazuki IZUMI, Kariya-city (JP); Yuuki OZAWA, Tokyo (JP); Ryu KAMBARA, Tokyo (JP); Koji SHIBATA, Tokyo (JP); Yuka SATRE, Tokyo (JP); Yuki YAMAMOTO, Tokyo (JP)

(21) Appl. No.: 19/293,807

(22) Filed: Aug. 7, 2025

Related U.S. Application Data
(63) Continuation of application No. PCT/JP2024/005303, filed on Feb. 15, 2024.

(30) Foreign Application Priority Data
Feb. 17, 2023 (JP) 2023-023003

(51) Int. Cl. B60W 30/18; B60Q 1/50; B60W 40/04; B60W 60/00

(52) U.S. Cl. CPC B60W 30/18159; B60Q 1/507; B60W 30/181; B60W 40/04; B60W 60/00272; B60W 60/0053; B60W 2552/05; B60W 2554/402; B60W 2554/4044; B60W 2554/4045

(57) ABSTRACT

An automated driving control device enables traveling of a subject vehicle by an automated driving function. The automated driving control device is configured to determine a priority relationship between the subject vehicle and another vehicle at a multi-stop intersection; determine whether a connection road connected to the multi-stop intersection is a narrow road on which it is difficult for the subject vehicle and the another vehicle to pass each other; and perform, at the multi-stop intersection, a travel control of the subject vehicle according to the priority relationship in a case where the connection road is not the narrow road, and performs a travel control that gives priority to traveling of the another vehicle in a case where the connection road is the narrow road.

### CROSS REFERENCE TO RELATED APPLICATIONS

The present application is a continuation application of International Patent Application No. PCT/JP2024/005303 filed on Feb. 15, 2024 which designated the U.S. and claims the benefit of priority from Japanese Patent Application No. 2023-023003 filed on Feb. 17, 2023. The entire disclosures of all of the above applications are incorporated herein by reference.

### TECHNICAL FIELD

The disclosure according to this specification relates to a technique of automated driving control that enables traveling of a subject vehicle by an automated driving function.

### BACKGROUND

A related art describes control of an autonomous traveling vehicle at a multi-stop intersection. A vehicle trying to travel through a multi-stop intersection must make a temporary stop before entering the multi-stop intersection. In a related art, in a case where the arrival time of the subject vehicle and the arrival time of another vehicle are substantially the same, the autonomous traveling vehicle performs the driving operation such as stopping or decelerating near the original temporary stop point.

### SUMMARY

According to an aspect of the present disclosure, an automated driving control device enables traveling of a subject vehicle by an automated driving function. The automated driving control device includes at least one of (i) a circuit and (ii) a processor with a memory storing computer program code executable by the processor, the at least one of the circuit and the processor configured to cause the automated driving control device to determine a priority relationship between the subject vehicle and another vehicle at a multi-stop intersection; determine whether a connection road connected to the multi-stop intersection is a narrow road on which it is difficult for the subject vehicle and the another vehicle to pass each other; and perform, at the multi-stop intersection, a travel control of the subject vehicle according to the priority relationship in a case where the connection road is not the narrow road, and performs a travel control that gives priority to traveling of the another vehicle in a case where the connection road is the narrow road.

### BRIEF DESCRIPTION OF DRAWINGS

Objects, features and advantages of the present disclosure will become more apparent from the following detailed description made with reference to the accompanying drawings. In the drawings:

FIG. 1 is a diagram illustrating an overall image of an in-vehicle network including an automated driving ECU according to the first embodiment of the present disclosure;

FIG. 2 is a block diagram illustrating details of an automated driving ECU;

FIG. 3 is a diagram for describing the scene 1 in which a vehicle travels through a multi-stop intersection together with FIG. 4;

FIG. 4 is a diagram for describing the scene 1 in which a vehicle travels through a multi-stop intersection together with FIG. 3;

FIG. 5 is a diagram for describing the scene 2 in which the vehicle travels through a multi-stop intersection;

FIG. 6 is a diagram for describing the scene 3 in which the vehicle is evacuated to an evacuation place to avoid an oncoming vehicle;

FIG. 7 is a diagram for describing the scene 4 in which the vehicle travels through a multi-stop intersection;

FIG. 8 is a diagram for describing the scene 5 in which the vehicle travels through a multi-stop intersection together with FIG. 9;

FIG. 9 is a diagram for describing the scene 5 in which the vehicle travels through a multi-stop intersection together with FIG. 8;

FIG. 10 is a diagram for describing the scene 6 in which the vehicle travels through a multi-stop intersection;

FIG. 11 is a diagram for describing the scene 7 in which the vehicle travels through a multi-stop intersection;

FIG. 12 is a diagram for describing the scene 8 in which the vehicle travels through a multi-stop intersection;

FIG. 13 is a diagram for describing the scene 9 in which the vehicle travels through a multi-stop intersection;

FIG. 14 is a flowchart illustrating details of the main process of a travel control process;

FIG. 15 is a flowchart illustrating details of an another vehicle priority process;

FIG. 16 is a flowchart illustrating details of an emergency evacuation process;

FIG. 17 is a flowchart illustrating details of a stop preparation process;

FIG. 18 is a flowchart illustrating details of an automated driving vehicle handling process;

FIG. 19 is a diagram for describing the scene in which the subject vehicle equipped with an automated driving ECU according to the second embodiment travels through a multi-stop intersection;

FIG. 20 is a flowchart illustrating details of the travel control process;

FIG. 21 is a diagram for describing the scene 10 in which the vehicle travels through a multi-stop intersection in the third embodiment;

FIG. 22 is a diagram for describing the scene 11 in which the vehicle travels through a multi-stop intersection;

FIG. 23 is a diagram for describing the scene 12 in which the vehicle travels through a multi-stop intersection;

FIG. 24 is a diagram for describing the scene 13 in which the vehicle travels through a multi-stop intersection;

FIG. 25 is a diagram for describing the scene 14 in which the vehicle travels through a multi-stop intersection;

FIG. 26 is a diagram for describing the scene 15 in which the vehicle travels through a multi-stop intersection;

FIG. 27 is a diagram for describing the scene 16 in which the vehicle travels through a multi-stop intersection together with FIG. 28; and

FIG. 28 is a diagram for describing the scene 16 in which the vehicle travels through a multi-stop intersection together with FIG. 27.

### DETAILED DESCRIPTION

The influence of another vehicle (or a different vehicle) and the like is larger in a complex intersection such as the multi-stop intersection of a related art than in a normal intersection where a traffic signal is installed, for example. Therefore, there may be room for improving convenience in the travel control of the automated driving performed at the multi-stop intersection.

The present disclosure provides an automated driving control device, an automated driving control program, and an automated driving control method capable of ensuring convenience of automated driving at a multi-stop intersection.

According to one aspect of the present disclosure, an automated driving control device enables traveling of a subject vehicle by an automated driving function. The automated driving control device includes: an another vehicle determination section configured to determine a priority relationship between the subject vehicle and another vehicle at a multi-stop intersection; a road determination section configured to determine whether a connection road connected to the multi-stop intersection is a narrow road on which it is difficult for the subject vehicle and the another vehicle to pass each other; and a travel control section configured to perform, at the multi-stop intersection, a travel control of the subject vehicle according to the priority relationship in a case where the connection road is not the narrow road, and performs a travel control that gives priority to traveling of the another vehicle in a case where the connection road is the narrow road.

In the aspect, in a case where the connection road connected to the multi-stop intersection is a narrow road, travel control that prioritizes traveling of another vehicle is performed. Therefore, the subject vehicle can smoothly travel through the multi-stop intersection in a state where another vehicle is caused to go first and the subject vehicle is not obstructed by the another vehicle. As a result, the convenience of the automated driving at the multi-stop intersection can be secured.

According to one aspect of the present disclosure, an automated driving control device enables traveling of a subject vehicle by an automated driving function. The automated driving control device includes a road determination section that determines whether a preceding intersection through which the subject vehicle traveling by autonomous travel control in which a driver is not obliged to monitor surroundings is scheduled to pass is a multi-stop intersection, and a control switching section that permits continuation of traveling by the autonomous travel control in a case where the preceding intersection is not the multi-stop intersection, and terminates the autonomous travel control in a case where the preceding intersection is the multi-stop intersection.

In these aspects, in a case where the preceding intersection through which the subject vehicle traveling by the autonomous travel control in which the driver is not obliged to monitor the surroundings is scheduled to pass is a multi-stop intersection, the autonomous travel control is terminated. According to such a planned driving-mode switch, the subject vehicle can smoothly travel through the multi-stop intersection. As a result, the convenience of the automated driving at the multi-stop intersection can be secured.

Hereinafter, a plurality of embodiments of the present disclosure will be described with reference to the drawings. The same reference numerals are given to corresponding components in each embodiment, and redundant description may be omitted. In a case where only part of the configuration is described in each embodiment, the configuration of the other embodiments described above can be applied to other parts of the configuration. In addition, not only a combination of configurations explicitly described in the description of each embodiment but also configurations of a plurality of embodiments can be partially combined even if not explicitly described as long as there is no problem in the combination. It is assumed that combinations of configurations described in a plurality of embodiments and modifications that is not explicitly described are also disclosed by the following description.

### First Embodiment

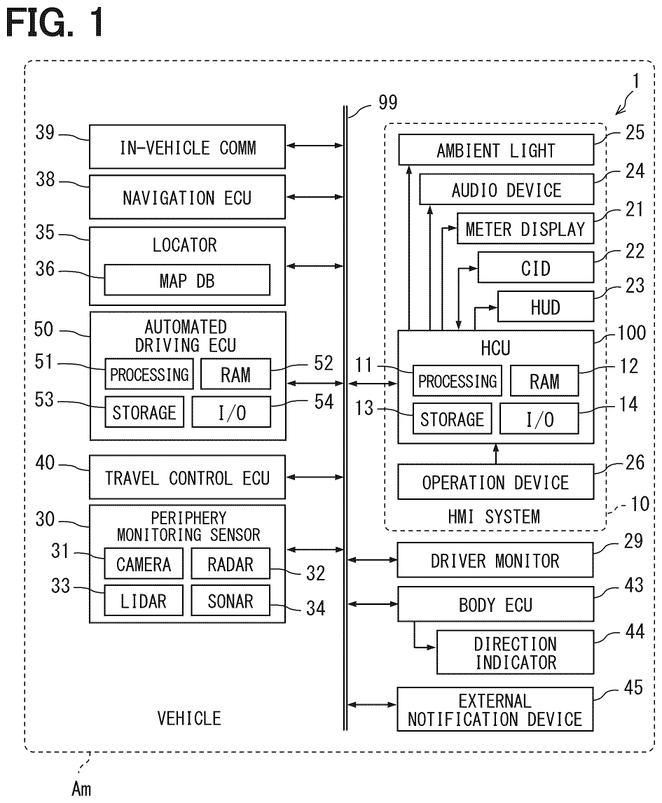

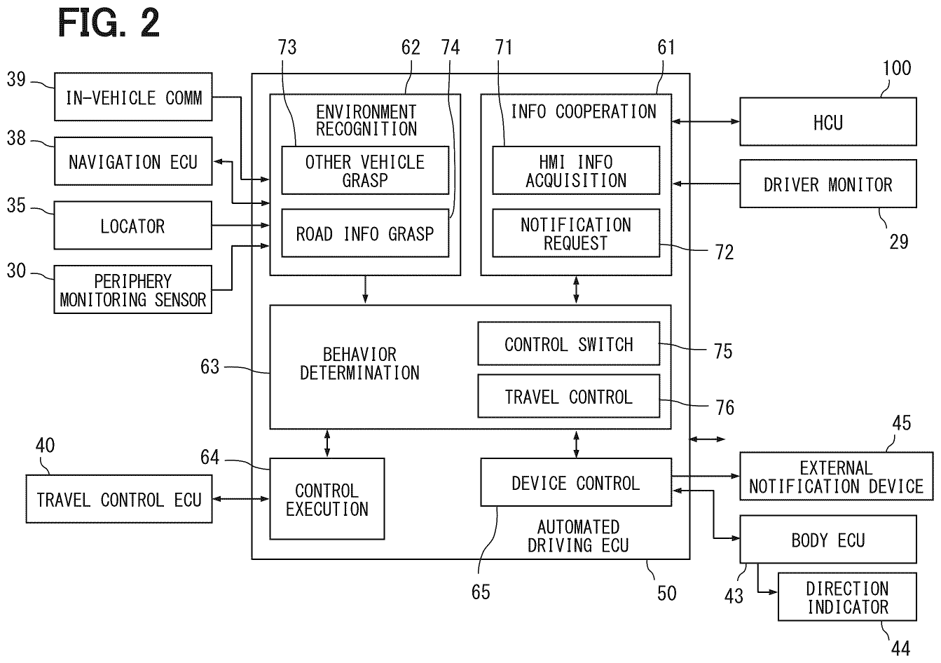

The function of the automated driving control device according to the first embodiment of the present disclosure is realized by an automated driving electronic control section (ECU) 50 illustrated in FIGS. 1 and 2. The automated driving ECU 50 is mounted on a vehicle (hereinafter, subject vehicle Am). By mounting the automated driving ECU 50, the subject vehicle Am is an automated driving vehicle or an autonomous traveling vehicle having an automated driving function, and can travel by the automated driving function.

The automated driving ECU 50 is an in-vehicle ECU that realizes an autonomous traveling function capable of performing a driving operation of a driver on behalf of the driver. The automated driving ECU 50 can perform advanced driving assistance or partial automated driving at about Level 2 and automated driving at Level 3 or higher in which the system is a control subject. The automated driving level in the present disclosure is based on a standard defined by Society of Automotive Engineers.

The automated driving at Level 2 is an automated driving (an eyes-on automated driving) that requires a driver to visually monitor the surroundings of the subject vehicle and has a surroundings monitoring obligation. The automated driving at Level 2 includes hands-on automated driving in which the driver is obliged to grip the steering wheel and hands-off automated driving in which the driver is not obliged to grip the steering wheel.

The automated driving at Level 3 is an eyes-off automated driving in which monitoring around the subject vehicle is unnecessary and there is no surroundings monitoring obligation. The automated driving ECU 50 may be capable of performing fully automated driving at Level 4 in which the system performs all driving tasks under certain conditions, and fully automated driving at Level 5 in which the system performs all driving tasks under all conditions. The automated driving at Level 4 is brain-off automated driving in which a request for a driving-mode switch to the driver does not substantially occur. The automated driving at Level 5 is driverless automated driving that does not require a driver to board.

The automated driving ECU 50 switches the control state of the automated driving function among a plurality of controls including at least automated driving control having a surroundings monitoring obligation at Level 2 or less and automated driving control having no surroundings monitoring obligation at Level 3 or more. In the following description, the automated driving control at Level 2 or lower is referred to as “driving assistance control”, and the automated driving control at Level 3 or higher is referred to as “autonomous travel control”.

In the automated traveling period during which the subject vehicle Am travels by the autonomous travel control, the driver can be permitted to perform a specific action (hereinafter, a second task) other than predetermined driving. The second task is legally permitted to the driver until generation of a driving-mode switch request performed by cooperation of a human machine interface control section (HCU) 100 and the automated driving ECU 50 described later. For example, actions such as viewing entertainment content such as moving image content, operation of a device such as a smartphone, and eating are assumed as the second tasks.

(Configuration of in-Vehicle System)

The automated driving ECU 50 is communicably connected to a communication bus 99 of an in-vehicle network 1 mounted on the subject vehicle Am. A driver monitor 29, a surroundings monitoring sensor 30, a locator 35, a navigation ECU 38, an in-vehicle communication device 39, a travel control ECU 40, a body ECU 43, an out-of-vehicle notification device 45, an HCU 100, and the like are connected to the communication bus 99. These nodes connected to the communication bus 99 can communicate with each other. Specific nodes among these ECUs and the like may be electrically connected directly to each other and may communicate with each other without passing through the communication bus 99. The surroundings monitoring sensor 30 may be referred to as a periphery monitoring sensor.

The driver monitor 29 includes a near-infrared light source, a near-infrared camera, and a control unit that controls these components. The driver monitor 29 is installed, for example, on the upper face of the steering column section or the upper face of the instrument panel in a posture in which the near-infrared camera faces the headrest portion of the driver seat. The driver monitor 29 photographs the head of the driver irradiated with the near-infrared light by the near-infrared light source with the near-infrared camera. The image captured by the near-infrared camera is subjected to image analysis by the control unit. The control unit extracts information such as the position and the line-of-sight direction of the eye point of the driver from the captured image. The driver monitor 29 provides the position information, the line-of-sight direction information, and the like of the eye point extracted by the control unit to the HCU 100, the automated driving ECU 50, and the like as driver status information.

The surroundings monitoring sensor 30 is an autonomous sensor that monitors the environment around the subject vehicle Am. The surroundings monitoring sensor 30 includes, for example, one or more of a camera unit 31, a millimeter wave radar 32, a LiDAR 33, and a sonar 34. The surroundings monitoring sensor 30 can detect a moving object and a stationary object from a detection range around the subject vehicle. The surroundings monitoring sensor 30 provides detection information about an object around the subject vehicle to the automated driving ECU 50 and the like.

The locator 35 includes a global navigation satellite system (GNSS) receiver, an inertial sensor, and the like. The locator 35 combines positioning signals received from a plurality of positioning satellites by the GNSS receiver, measurement results by the inertial sensor, vehicle speed information output to the communication bus 99, and the like to sequentially measure the position, the traveling direction, and the like of the subject vehicle Am. The locator 35 sequentially outputs the position information and the direction information of the subject vehicle Am based on the positioning result to the communication bus 99 as locator information.

The locator 35 further includes a map database (hereinafter, map DB) 36 storing map data. The map DB 36 mainly includes a large-capacity storage medium storing a large number of pieces of three-dimensional map data and two-dimensional map data. The three-dimensional map data is a so-called high definition (HD) map, and includes road information necessary for automated driving. Specifically, the three-dimensional map data includes three-dimensional shape information of the road, detailed information of each lane, and the like. The locator 35 can update the three-dimensional map data and the two-dimensional map data to the latest information by out-of-vehicle communication by the in-vehicle communication device 39. The locator 35 reads map data around the current position from the map DB 36, and provides the map data together with locator information to the automated driving ECU 50, the HCU 100, and the like.

The navigation ECU 38 acquires information about a destination designated by an occupant such as a driver based on the operation information acquired from the HCU 100. The navigation ECU 38 acquires subject vehicle position information and direction information from the locator 35, and sets a route from the current position to the destination. The navigation ECU 38 provides route information indicating a setting route to a destination to the automated driving ECU 50, the HCU 100, and the like. The navigation ECU 38 cooperates with an HMI system 10 to combine a screen display, a voice message, and the like as route guidance to the destination, and notifies the driver of the traveling direction of the subject vehicle Am at the intersection, the branch point, and the like.

Here, a user terminal such as a smartphone may be connected to the in-vehicle network 1 or the HCU 100. Such a user terminal may provide subject vehicle position information, direction information, map data, and the like to the automated driving ECU 50 and the like instead of the locator 35. Further, instead of the navigation ECU 38, the user terminal may provide route information to the destination to the automated driving ECU 50, the HCU 100, and the like.

The in-vehicle communication device 39 is an out-of-vehicle communication unit mounted on the subject vehicle Am, and functions as a vehicle to everything (V2X) communication device. The in-vehicle communication device 39 transmits and receives information to and from a roadside device installed beside the road and another vehicle around the subject vehicle by wireless communication. As an example, the in-vehicle communication device 39 receives congestion information, traffic regulation information, and the like around the current position and in the traveling direction of the subject vehicle Am from a roadside device. The congestion information and the traffic regulation information are, for example, VICS (registered trademark) information and the like.

The in-vehicle communication device 39 may be capable of receiving signal information indicating a lighting pattern of a traffic signal installed at the preceding intersection, and detection information about objects around the preceding intersection, for example, a stopped vehicle, a parked vehicle, a pedestrian, a cyclist, and the like from a roadside device and another vehicle. The in-vehicle communication device 39 provides the received congestion information, traffic regulation information, signal information, detection information, and the like to the automated driving ECU 50, the HCU 100, and the like.

The travel control ECU 40 is an electronic control device mainly including a microcontroller. The travel control ECU 40 generates vehicle speed information indicating the current traveling speed of the subject vehicle Am based on the detection signal of the wheel speed sensor provided in the hub portion of each wheel, and sequentially outputs the generated vehicle speed information to the communication bus 99. The travel control ECU 40 has at least functions of a brake control ECU, a drive control ECU, and a steering control ECU. The travel control ECU 40 continuously performs braking force control of each wheel, output control of an in-vehicle power source, and steering angle control based on an operation command based on a driving operation of a driver or a control command of the automated driving ECU 50.

The body ECU 43 is an electronic control device mainly including a microcontroller. The body ECU 43 has at least a function of controlling an operation of a lighting device (for example, the direction indicator 44 or the like) mounted on the subject vehicle Am. The body ECU 43 starts blinking of one of left and right direction indicators 44 (blinker) corresponding to an operation direction based on detection of a user operation input to a direction indication switch provided in a steering column section or the like. In addition, based on the control command received from the automated driving ECU 50, the body ECU 43 causes one of the left and right direction indicators 44 corresponding to the moving direction of the subject vehicle Am to start blinking in a case of the automated lane change or the right or left turn by the driving assistance control or the autonomous travel control.

The out-of-vehicle notification device 45 includes an out-of-vehicle display that displays information toward the outside of the subject vehicle Am. The out-of-vehicle display may be configured to display characters, or may be configured to indicate information by a change in a light emitting aspect. The out-of-vehicle display is installed on the front face of the subject vehicle Am in a posture with the display face facing in front of the subject vehicle Am. As an example, the out-of-vehicle display is disposed in a range between the pair of left and right headlights in the front end of the subject vehicle Am. The out-of-vehicle notification device 45 may include out-of-vehicle displays installed on both left and right side faces of the subject vehicle Am, or may include an out-of-vehicle display installed on the rear face of the subject vehicle Am in a posture with the display face facing rearward. Furthermore, the out-of-vehicle notification device 45 may include a speaker that outputs sound toward the outside of the vehicle. The out-of-vehicle notification device 45 may be referred to as an external notification device.

The HCU 100 constitutes a human machine interface (HMI) system 10 together with a plurality of display devices, an audio device 24, an ambient light 25, an operation device 26, and the like. The HMI system 10 has an input interface function of receiving an operation by an occupant such as a driver of the subject vehicle Am and an output interface function of presenting information to the driver.

The display device presents information through the vision of the driver by image display or the like. The display devices include a meter display 21, a center information display (CID) 22, a head-up display (hereinafter, HUD) 23, and the like. The CID 22 has a touch panel function, and detects a touch operation on a display screen by a driver or the like.

The audio device 24 includes a plurality of speakers installed in the vehicle interior in an arrangement surrounding the driver seat, and causes the speakers to reproduce a notification sound, a voice message, or the like in the vehicle interior. The ambient light 25 is provided on an instrument panel, a steering wheel, and the like. The ambient light 25 performs information presentation using the surroundings field of view of the driver by ambient display that changes the emission color.

The operation device 26 is an input section that receives a user operation by a driver or the like. For example, a user operation related to the operation and stop of the automated driving function, a user operation related to the setting of the destination of the route guidance, and the like are input to the operation device 26. The operation device 26 includes a steering switch provided on a spoke portion of a steering wheel, an operation lever provided on a steering column section, a voice input device that recognizes utterance content of a driver, and the like.

The HCU 100 is a computer mainly including a control circuit including a processing section 11, a RAM 12, a storage section 13, an input/output interface 14, a bus connecting these, and the like. The HCU 100 functions as a presentation control device, and integrally controls information presentation using a plurality of display devices, the audio device 24, and the ambient light 25.

The HCU 100 presents information related to the automated driving in cooperation with the automated driving ECU 50. The HCU 100 acquires, from the automated driving ECU 50, control status information indicating an operation state of the automated driving function and a request for execution of information presentation related to the automated driving function. The HCU 100 performs content provision and information presentation in accordance with the operation state of the automated driving based on the control status information and the execution request. For example, in a case where the autonomous travel control is scheduled to be terminated by the automated driving ECU 50, the HCU 100 makes a notification of requesting execution of the driving operation, in other words, a notification of requesting a driving-mode switch (suggestion).

The HCU 100 acquires operation information indicating the content of the user operation from the CID 22, the operation device 26, and the like. The HCU 100 provides the automated driving ECU 50 with operation information about a user operation related to the automated driving function. The HCU 100 provides the navigation ECU 38 with operation information about a user operation for setting a destination of the subject vehicle Am.

### (Configuration of Automated Driving ECU)

The automated driving ECU 50 is a computer mainly including a control circuit including a processing section 51, a RAM 52, a storage section 53, an input/output interface 54, a bus connecting these, and the like. The processing section 51 executes various processes (instructions) for realizing the automated driving control method of the present disclosure by accessing the RAM 52. The storage section 53 stores various programs (automated driving control programs and the like) executed by the processing section 51. By execution of the program by the processing section 51, in the automated driving ECU 50, an information linkage section 61, an environment recognition section 62, an action determination section 63, a control execution section 64, a device control section 65, and the like are constructed as a plurality of function sections for realizing the automated driving function (see FIG. 2). The information linkage section 61 may be referred to as an information cooperation section. The action determination section 63 may be referred to as a behavior determination section.

The information linkage section 61 provides information to the HCU 100 and acquires information from the HCU 100 and the driver monitor 29. The information linkage section 61 acquires control state information indicating an operation state of the automated driving function from the action determination section 63, and provides the acquired control state information to the HCU 100. The control state information includes information indicating the automated driving level of the automated driving function in the operation state. The information linkage section 61 includes an HMI information acquisition section 71 and a notification request section 72 as sub-function sections for information linkage with the HCU 100 and the driver monitor 29.

The HMI information acquisition section 71 grasps the content of the user operation input to the CID 22, the operation device 26, and the like by the driver and the like based on the operation information acquired from the HCU 100. The HMI information acquisition section 71 grasps, for example, a Level 2 transition operation for instructing a transition from manual driving to driving assistance control, a Level 3 transition operation for instructing a transition from driving assistance control to autonomous travel control, and the like. Further, the HMI information acquisition section 71 grasps the action of the driver based on the driver status information acquired from driver monitor 29. The HMI information acquisition section 71 continuously grasps the driving posture, the line-of-sight direction, whether the surroundings monitoring is performed, whether the second task is performed, the degree of awakening, and the like of the driver during the traveling period by the driving assistance control or the autonomous travel control.

The notification request section 72 enables notification by the HCU 100 synchronized with the operation state of the automated driving function by outputting the notification execution request to the HCU 100. For example, in a case where the termination of the autonomous travel control is scheduled, the notification request section 72 outputs an execution request for a notification of requesting a driving-mode switch to the HCU 100. Based on the notification request acquired from the notification request section 72, the HCU 100 makes a notification in which virtual image display or screen display by the display device, reproduction of a notification sound or message by the audio device 24, ambient display by the ambient light 25, and the like are appropriately combined.

The environment recognition section 62 combines the locator information and the map data acquired from the locator 35 with the detection information acquired from the surroundings monitoring sensor 30 to recognize the travel environment of the subject vehicle Am. The environment recognition section 62 can use the detection information received by the in-vehicle communication device 39 for recognition of the travel environment. The environment recognition section 62 acquires route information from the navigation ECU 38 and provides the acquired route information to the action determination section 63. The environment recognition section 62 acquires, from communication bus 99, vehicle speed information indicating a current traveling speed as information indicating a state of subject vehicle Am. The environment recognition section 62 includes an another vehicle grasping section 73 and a road grasping section 74 as sub-function sections for travel environment recognition. The road grasping section 74 may be referred to as a road information grasp section.

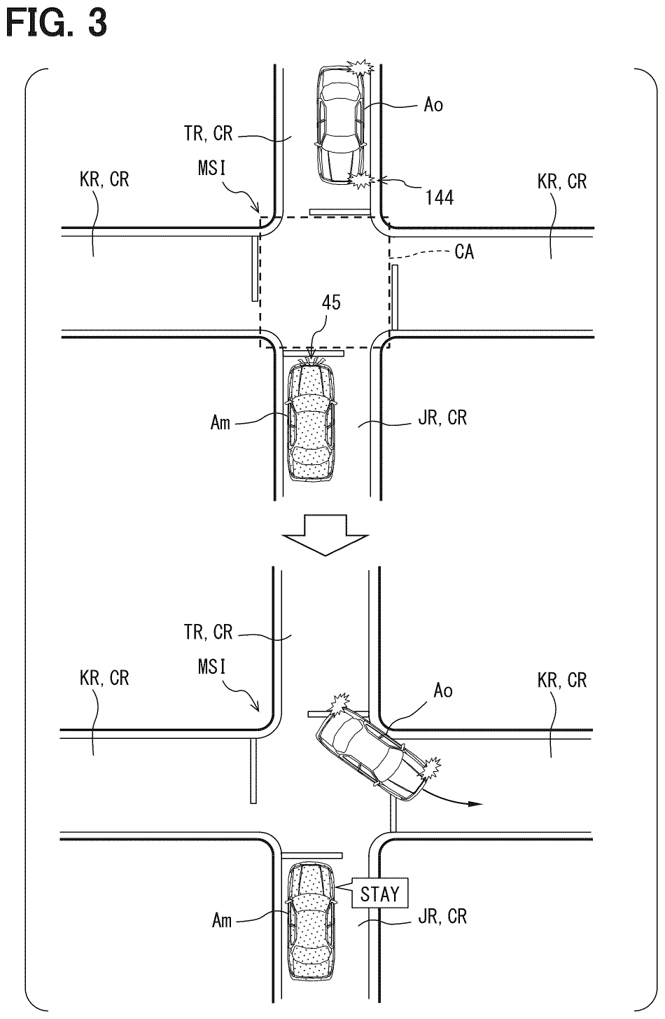

The another vehicle grasping section 73 grasps a relative position, a relative speed, and the like of a dynamic target around the subject vehicle, such as another vehicle traveling around the subject vehicle Am. The another vehicle grasping section 73 detects other vehicles such as a preceding vehicle, a side vehicle, and a following vehicle of the subject vehicle Am at a multi-stop intersection MSI (see FIG. 3) described later, for example, and grasps the relative position, the relative speed, and the like of the detected other vehicles.

The road grasping section 74 acquires information related to a road on which the subject vehicle Am travels or a road on which the subject vehicle Am is scheduled to travel. The road grasping section 74 grasps the type of the preceding intersection through which the subject vehicle Am traveling by the autonomous travel control is scheduled to pass based on map data or the like. The road grasping section 74 determines whether the preceding intersection is, for example, a multi-stop intersection MSI (see FIG. 3) to be described later.

The road grasping section 74 grasps whether the road on which the subject vehicle Am travels or the road on which the subject vehicle Am is scheduled to travel is within a preset permitted area. In the permitted area, the execution of the autonomous travel control at Level 3 or higher is permitted. The condition as to whether the area is a permitted area corresponds to a road condition in an operational design domain. The operational design domain is a unique condition related to a design travel environment that is a premise on which the automated driving ECU 50 normally operates, and is set according to the ability of the automated driving ECU 50. The information indicating whether the area is a permitted area may be recorded in map data stored in the map DB 36 or may be included in reception information received by the in-vehicle communication device 39.

In a case where the automated driving ECU 50 has the control right of the driving operation, the action determination section 63 generates a scheduled travel line on which the subject vehicle Am travels based on the recognition result of the travel environment by the environment recognition section 62 and the route information generated by the navigation ECU 38. The action determination section 63 outputs the generated scheduled travel line to the control execution section 64. The action determination section 63 includes the control switching section 75 as a sub-function section that controls the operation state of the automated driving function.

The control switching section 75 cooperates with the HCU 100 to control the driving-mode switch between the automated driving ECU 50 and the driver. The control switching section 75 switches between driving assistance control at Level 2 in which the driver is obliged to monitor the surroundings and autonomous travel control at Level 3 or higher in which the driver is not obliged to monitor the surroundings. The control switching section 75 permits the execution of automated driving at Level 3 or higher on roads within the permitted area, and permits only the execution automated driving at Level 2 on roads outside the permitted area. Further, the control switching section 75 performs switching between the automated driving at Level 3 and the automated driving at Level 4 or Level 5 in the autonomous travel control without the surroundings monitoring obligation. The control switching section 75 generates control state information indicating a current operation state of the automated driving function, and provides the generated control state information to the information linkage section 61 or the like.

In a case where the automated driving ECU 50 has the control right of the driving operation, the control execution section 64 executes acceleration/deceleration control, steering control, and the like of the subject vehicle Am in accordance with the scheduled travel line generated by the action determination section 63 in cooperation with the travel control ECU 40. Specifically, the control execution section 64 generates a control command based on the scheduled travel line, and sequentially outputs the generated control command to the travel control ECU 40.

The device control section 65 controls the start and termination of the blinking operation of the direction indicator 44 by outputting a control command to the body ECU 43. The device control section 65 performs the blinking operation of the direction indicator 44 close to the adjacent lane Lnd in cooperation with the body ECU 43 in accordance with the execution of the automated lane change by the driving assistance control or the autonomous travel control. In addition, the device control section 65 controls the out-of-vehicle notification device 45 to notify another vehicle, pedestrians, and the like outside the vehicle that the subject vehicle Am is traveling by the automated driving function in a scene in which the subject vehicle travels through an intersection or the like.

### (Travel Control at Multi-Stop Intersection)

Next, details of travel control performed by the automated driving ECU 50 in a scene where the subject vehicle Am travels through the multi-stop intersection MSI (see FIG. 3) will be described.

The multi-stop intersection MSI includes a common region CA that the vehicle can approach from a plurality of directions. A vehicle traveling through the multi-stop intersection MSI is to stop before proceeding to the common region CA in accordance with an instruction of a traffic control element such as a stop sign, a red blinking light, a road mark, and a stop line. The multi-stop intersection MSI may include various aspects such as an omnidirectional temporary stop, a bidirectional temporary stop, and a tridirectional temporary stop.

In a case where the subject vehicle Am is scheduled to travel through the multi-stop intersection MSI, the road grasping section 74 determines whether the connection road CR connected to the multi-stop intersection MSI is a narrow road. The narrow road is a road having a narrow road width where vehicles are difficult to pass each other. The road grasping section 74 may set a narrow street or the like registered in the map data as a narrow road, or may set a road having a road width narrower than a predetermined value as a narrow road based on detection information of the surroundings monitoring sensor 30. The value serving as the threshold value for the narrow road determination may be a preset value, or may be a value set based on at least one of the vehicle width of the subject vehicle Am and the vehicle width of another vehicle detected by the surroundings monitoring sensor 30. Further, the road grasping section 74 may set a road without a center line, in other words, a road in which the road is not divided into a subject vehicle lane and an opposite lane as a narrow road.

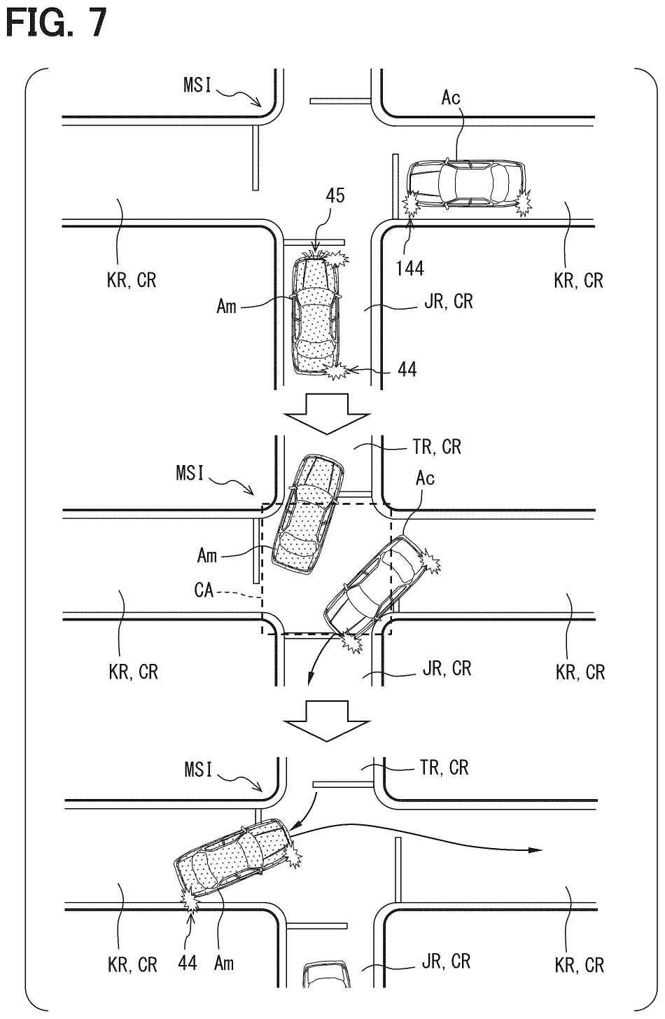

Here, in the following description, a road on which the subject vehicle Am is located among the connection roads CR connected to the multi-stop intersection MSI is defined as a subject vehicle road JR. Further, a road in a direction intersecting the subject vehicle road JR is defined as an intersecting road KR. A road opposite to the subject vehicle road JR across the intersecting road KR is defined as an opposite road TR. In addition, another vehicle traveling on the intersecting road KR toward the common region CA is defined as an intersection vehicle Ac (see FIG. 7), and another vehicle traveling on the opposite road TR toward the common region CA is defined as an oncoming vehicle Ao.

The another vehicle grasping section 73 recognizes another vehicle entering the multi-stop intersection MSI from the connection road CR different from that of the subject vehicle Am at the multi-stop intersection MSI. The another vehicle grasping section 73 acquires information for estimating the traveling direction at the multi-stop intersection MSI for the grasped another vehicle. For example, the another vehicle grasping section 73 acquires detection results of the operation status of a direction indicator 144, the line-of-sight direction of the occupant of the another vehicle, the direction of the steering wheel of the another vehicle, and the like.

The another vehicle grasping section 73 determines the priority relationship between the subject vehicle Am and the another vehicle at the multi-stop intersection MSI. The another vehicle grasping section 73 identifies times of arrival of the subject vehicle Am and the another vehicle at the multi-stop intersection MSI, and sets a vehicle that arrives first at the multi-stop intersection MSI among the subject vehicle Am and the another vehicle as a priority side. Further, in a case where the subject vehicle Am and the another vehicle arrive at the multi-stop intersection MSI substantially at the same time, the another vehicle grasping section 73 sets the left vehicle as the priority side in a case of the left-hand traffic road, and sets the right vehicle as the priority side in a case of the light-hand traffic road.

The action determination section 63 includes a travel control section 76 as a sub-function section. In a case where the connection road CR is not a narrow road at the multi-stop intersection MSI, the travel control section 76 performs travel control of the subject vehicle Am according to the priority relationship determined by the another vehicle grasping section 73. On the other hand, in a case where the connection road CR is a narrow road, the travel control section 76 performs travel control in which traveling of another vehicle is prioritized over traveling of the subject vehicle Am.

Hereinafter, details of a plurality of scenes in which the vehicle travels through the multi-stop intersection MSI in which at least one of the connection roads CR is a narrow road will be described with reference to FIGS. 1 and 2 based on FIGS. 3 to 13. In each of the scenes illustrated in FIGS. 3 to 13, all of the connection roads CR are determined to be narrow roads. In each scene illustrated in FIGS. 3 to 5 and FIGS. 7 to 12, the out-of-vehicle notification using the out-of-vehicle notification device 45 is made.

### (Scene 1: Right or Left Turning Priority Scene of Oncoming Vehicle)

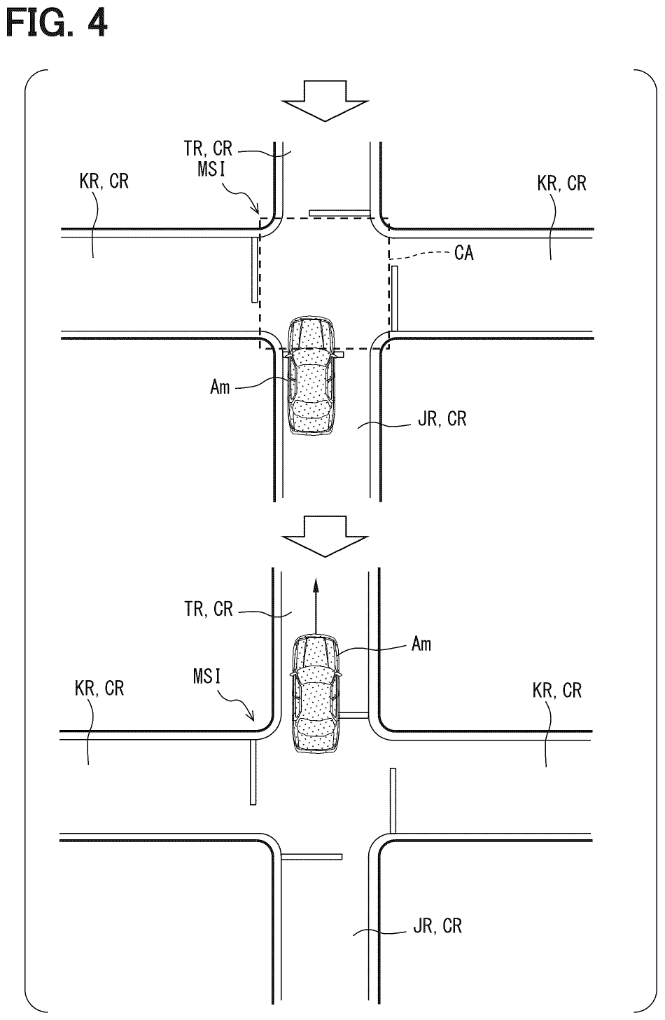

In the scene 1 illustrated in FIGS. 3 and 4, the subject vehicle Am and oncoming vehicle Ao are approaching the multi-stop intersection MSI. The subject vehicle Am is scheduled to travel straight through the multi-stop intersection MSI. The oncoming vehicle Ao is scheduled to make a left turn at the multi-stop intersection MSI. The oncoming vehicle Ao blinks the left direction indicator 144. The subject vehicle Am reaches the common region CA earlier than the oncoming vehicle Ao.

The another vehicle grasping section 73 estimates a timing at which the oncoming vehicle Ao reaches the multi-stop intersection MSI. The another vehicle grasping section 73 determines that the priority of the subject vehicle Am is higher than that of the oncoming vehicle Ao based on the arrival timing to the multi-stop intersection MSI. The another vehicle grasping section 73 estimates the traveling direction (left turning direction) of the oncoming vehicle Ao at the multi-stop intersection MSI based on the detection of the blinking operation of the direction indicators 144 of the oncoming vehicle Ao (see the upper part of FIG. 3).

Based on the narrow road determination of the connection road CR by the road grasping section 74, the travel control section 76 performs travel control that gives priority to the oncoming vehicle Ao regardless of the determination of priority or non-priority of the subject vehicle Am and the oncoming vehicle Ao. The travel control section 76 causes the oncoming vehicle Ao to preferentially travel in a case where it is estimated that the oncoming vehicle Ao will arrive within a predetermined time (for example, about 5 seconds) even if the subject vehicle Am first arrives at the common region CA.

The another vehicle grasping section 73 estimates that the oncoming vehicle Ao moves to the connection road CR (intersecting road KR) different from the subject vehicle road JR. Based on such estimation, the travel control section 76 sets the position before the stop line where the subject vehicle is temporarily stopped as the standby position. The travel control section 76 performs control of causing the subject vehicle Am to wait at a standby position set on the subject vehicle road JR and cause the oncoming vehicle Ao to go first.

At the multi-stop intersection MSI, the device control section 65 notifies the oncoming vehicle Ao that the subject vehicle Am is traveling by the automated driving function using the out-of-vehicle notification device 45. Further, the device control section 65 notifies the oncoming vehicle Ao that the right turn of the oncoming vehicle Ao is scheduled to be prioritized using the out-of-vehicle notification device 45. Based on such information presentation, the oncoming vehicle Ao turns left at the multi-stop intersection MSI and proceeds to the intersecting road KR (see the lower part of FIG. 3).

In a case where the standby state for giving priority to the oncoming vehicle Ao continues for more than a predetermined time (for example, about 10 seconds), the travel control section 76 terminates the standby state. For example, in a case where the oncoming vehicle Ao does not start turning left or in a case where the next oncoming vehicle Ao occurs, the standby state is timed out. In this case, the travel control section 76 cancels the stop state and starts the subject vehicle Am from the standby position in the straight traveling direction.

After starting from the standby position, the travel control section 76 performs look-in control for sensing the intersection vehicle Ac in the left-right direction. By the look-in control, the subject vehicle Am enters the common region CA of the multi-stop intersection MSI at a very low speed (slow down) in order to detect the situation of the intersection vehicle Ac and the intersecting road KR (see the upper part of FIG. 4). When the absence of the intersection vehicle Ac in the left-right direction is confirmed by the another vehicle grasping section 73 by the execution of the look-in control, the travel control section 76 causes the subject vehicle Am to travel in the straight traveling direction toward the opposite road TR (see the lower part of FIG. 4).

### (Scene 2: Scene of Passing Oncoming Vehicle)

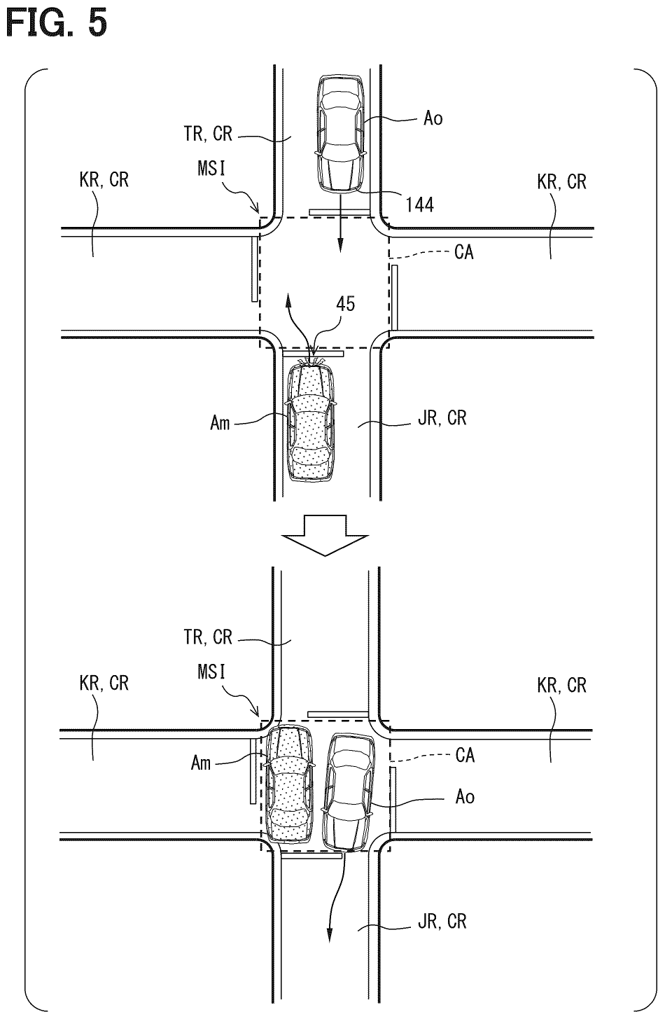

In the scene 2 illustrated in FIG. 5, the subject vehicle Am and oncoming vehicle Ao are approaching the multi-stop intersection MSI. Both the subject vehicle Am and the oncoming vehicle Ao are scheduled to travel straight through the multi-stop intersection MSI. The another vehicle grasping section 73 estimates the traveling direction (straight traveling direction) of the oncoming vehicle Ao at the multi-stop intersection MSI based on the detection that the direction indicators 144 of the oncoming vehicle Ao are not blinking.

The travel control section 76 performs travel control that gives priority to the oncoming vehicle Ao based on the narrow road determination of the connection road CR by the road grasping section 74. In a case where it is estimated that the oncoming vehicle Ao moves to the subject vehicle road JR and the subject vehicle Am obstructs traveling of the oncoming vehicle Ao, the travel control section 76 moves the subject vehicle Am to a standby position where the subject vehicle Am does not obstruct traveling of the oncoming vehicle Ao (see the upper part of FIG. 5).

In a case where the standby position is not allowed to be set on the connection road CR as in the scene 2, the travel control section 76 sets the standby position in the common region CA of the multi-stop intersection MSI. The standby position is set at a position closer to the road shoulder around the multi-stop intersection MSI than the center of the multi-stop intersection MSI. During such movement to the standby position, the out-of-vehicle notification device 45 notifies the oncoming vehicle Ao that the subject vehicle Am is traveling by the automated driving function and that the oncoming vehicle Ao is prioritized to travel straight.

The travel control section 76 moves the subject vehicle Am to the standby position set in the common region CA of the multi-stop intersection MSI, and causes the subject vehicle Am to wait (temporarily stop) in the common region CA (see the lower part of FIG. 5). In other words, the travel control section 76 evacuates the subject vehicle Am from the subject vehicle road JR with the common region CA as an evacuation place. As a result, the subject vehicle Am can give way to the oncoming vehicle Ao.

After the subject vehicle Am and the oncoming vehicle Ao are away from each other, when the movement of the oncoming vehicle Ao from the common region CA to the subject vehicle road JR is confirmed by the another vehicle grasping section 73, the travel control section 76 causes the subject vehicle Am to travel toward the opposite road TR. As described above, in a case where the subject vehicle Am and the oncoming vehicle Ao pass each other, the subject vehicle Am passes through the multi-stop intersection MSI so as to make a large turn more outward than usual while slowly traveling.

### (Scene 3: Scene of Evacuation for Avoiding Oncoming Vehicle)

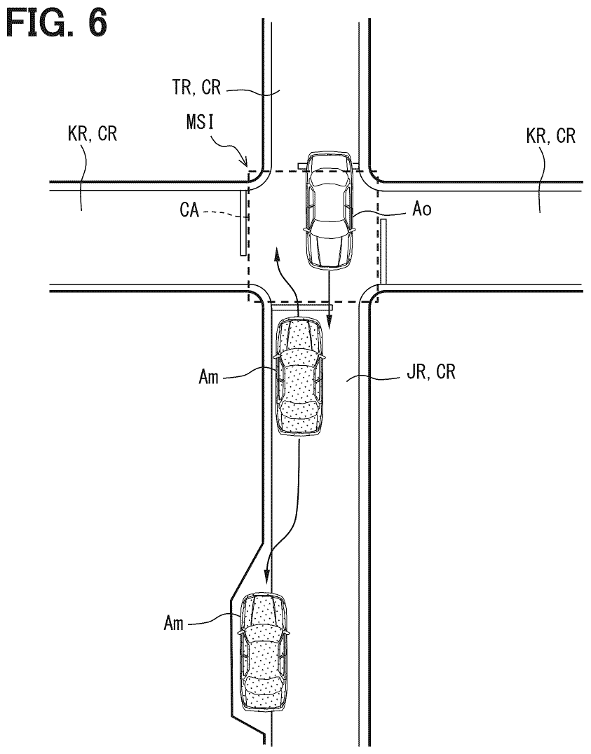

In the scene 3 illustrated in FIG. 6, the subject vehicle Am and oncoming vehicle Ao are approaching the multi-stop intersection MSI. Both the subject vehicle Am and the oncoming vehicle Ao are scheduled to travel straight through the multi-stop intersection MSI. The oncoming vehicle Ao attempts to forcibly travel to the subject vehicle road JR. In a case where the oncoming vehicle Ao forcibly enters the subject vehicle road JR, the road grasping section 74 determines whether there is an evacuation place where the subject vehicle Am is allowed to be evacuated in front of or behind the subject vehicle Am. In an emergency, a sidewalk, a roadside strip, and the like of the respective connection roads CR and the multi-stop intersections MSI are used as evacuation places.

In a case where there is an evacuation place, the travel control section 76 moves the subject vehicle Am to the evacuation place identified by the road grasping section 74. In a case where there are the evacuation places in front of and behind the subject vehicle Am, the travel control section 76 moves (advances) the subject vehicle Am to the evacuation place in front of the subject vehicle Am (see, for example, common region CA, FIG. 5). On the other hand, in a case where there is an evacuation place only behind the subject vehicle Am, the travel control section 76 moves (moves backward) the subject vehicle Am toward the evacuation place behind. For example, the evacuation place is set in a range including a widened road shoulder of the subject vehicle road JR. The travel control section 76 temporarily stops the subject vehicle Am at the evacuation place and waits for passage of the oncoming vehicle Ao.

Here, in a case where there is no evacuation place either in front of or behind the subject vehicle Am, the control switching section 75 performs the driving-mode switch from the automated driving function to the driving operator. As a result, the driving assistance control or the autonomous travel control is terminated, and the manual driving operation by the driver is started.

(Scene 4: Scene of Evacuation from Subject Vehicle Road for Giving Way to Intersection Vehicle)

In the scene 4 illustrated in FIG. 7, the subject vehicle Am and the intersection vehicle Ac are approaching the multi-stop intersection MSI. The subject vehicle Am is scheduled to turn right at the multi-stop intersection MSI. The intersection vehicle Ac approaches the multi-stop intersection MSI from right of the subject vehicle Am. The intersection vehicle Ac is scheduled to turn left at the multi-stop intersection MSI.

The another vehicle grasping section 73 estimates the traveling direction (left turning direction) of the intersection vehicle Ac at the multi-stop intersection MSI based on the detection of the blinking operation of the direction indicators 144. The another vehicle grasping section 73 estimates that the intersection vehicle Ac moves to the subject vehicle road JR. In the scene 4, the intersection vehicle Ac is present on the intersecting road KR beyond a right turn that the subject vehicle Am wants to make, and the subject vehicle Am is present on the subject vehicle road JR beyond a left turn that the intersection vehicle Ac wants to make (see the upper part of FIG. 7).

The travel control section 76 performs travel control that gives priority to the intersection vehicle Ac based on the narrow road determination of the connection road CR by the road grasping section 74. In the scene 4, since the subject vehicle Am obstructs traveling of the intersection vehicle Ac, the travel control section 76 moves the subject vehicle Am to a standby position where the subject vehicle Am does not obstruct the intersection vehicle Ac. The device control section 65 may stop the blinking operation of the direction indicator 44 during the period in which the subject vehicle Am moves to the standby position.

The travel control section 76 sets a standby position in a range across the opposite road TR and the common region CA. In a case where the oncoming vehicle Ao is not present, the opposite road TR is used as an evacuation place for the subject vehicle Am. The travel control section 76 moves the subject vehicle Am to the standby position to cause the subject vehicle Am to leave the subject vehicle road JR. The travel control section 76 causes the subject vehicle Am to wait (temporarily stop) at a standby position across the common region CA and the intersecting road KR (see the middle part of FIG. 7). As a result, the intersection vehicle Ac can turn left toward the subject vehicle road JR.

When the movement of the intersection vehicle Ac to the subject vehicle road JR is confirmed by the another vehicle grasping section 73, the travel control section 76 moves the subject vehicle Am backward toward the left intersecting road KR. After the blinking operation of the direction indicator 44 is resumed, the travel control section 76 causes the subject vehicle Am to travel toward the intersecting road KR in the right-turn direction (see the lower part of FIG. 7). As described above, the right turn of the subject vehicle Am after giving way to the intersection vehicle Ac is completed.

(Scene 5: Scene of Evacuation from Subject Vehicle Road for Giving Way to a Plurality of Other Vehicles)

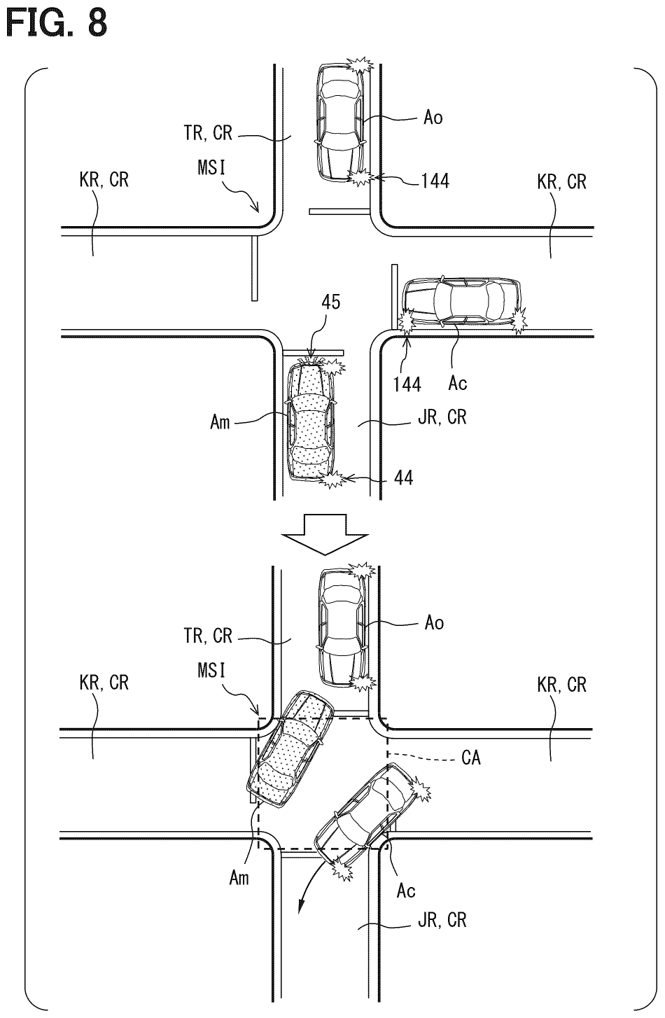

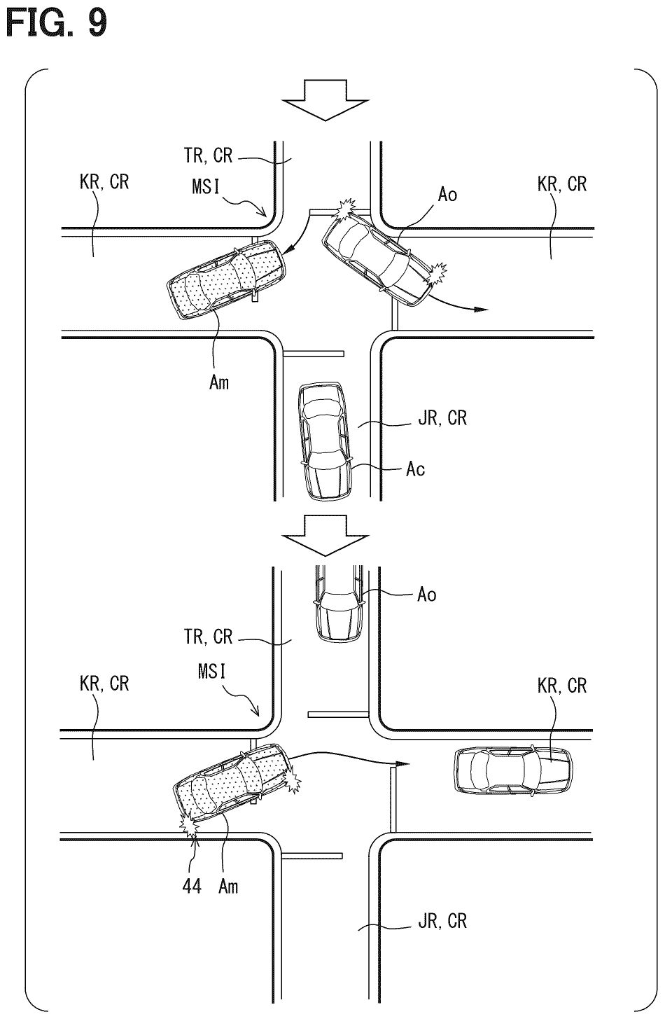

In the scene 5 illustrated in FIGS. 8 and 9, the subject vehicle Am, the oncoming vehicle Ao, and the intersection vehicle Ac are approaching the multi-stop intersection MSI. The subject vehicle Am is scheduled to turn right at the multi-stop intersection MSI. The oncoming vehicle Ao is scheduled to turn left at the multi-stop intersection MSI. The intersection vehicle Ac approaches the multi-stop intersection MSI from right of the subject vehicle Am. The intersection vehicle Ac is scheduled to turn left at the multi-stop intersection MSI.

The another vehicle grasping section 73 estimates the traveling direction (left turning direction) of the oncoming vehicle Ao and the intersection vehicle Ac at the multi-stop intersection MSI based on the detection of the blinking operation of each direction indicator 144. In the scene 5, there is the intersection vehicle Ac on the intersecting road KR, ahead of the subject vehicle Am and the oncoming vehicle Ao, on which the subject vehicle Am and the oncoming vehicle Ao want to travel. Further, there is the subject vehicle Am on subject vehicle road JR, beyond a left turn, on which the intersection vehicle Ac wants to travel (see an upper part of FIG. 8).

The travel control section 76 performs travel control that gives priority to the oncoming vehicle Ao and the intersection vehicle Ac based on the narrow road determination of the connection road CR by the road grasping section 74. In the scene 5, as in the scene 4 (see FIG. 7), since the subject vehicle Am obstructs traveling of the intersection vehicle Ac, the travel control section 76 moves the subject vehicle Am to a standby position where the subject vehicle Am does not obstruct the intersection vehicle Ac.

The travel control section 76 sets a standby position in a range across the opposite road TR and the common region CA. The travel control section 76 moves the subject vehicle Am to the set standby position while preventing the subject vehicle Am from contacting the oncoming vehicle Ao (see the lower part of FIG. 8). By evacuating the subject vehicle Am to the standby position, the intersection vehicle Ac can turn left toward the subject vehicle road JR.

When the movement of the intersection vehicle Ac to the subject vehicle road JR is confirmed by the another vehicle grasping section 73, the travel control section 76 moves the subject vehicle Am backward toward the left intersecting road KR (see the upper part of FIG. 9). The travel control section 76 evacuates the subject vehicle Am to the intersecting road KR in order to give way to the oncoming vehicle Ao. As a result, the oncoming vehicle Ao can turn left toward the intersecting road KR.

In a case where the oncoming vehicle Ao travels in the scheduled traveling direction of the subject vehicle Am, the travel control section 76 starts the subject vehicle Am so as to follow the oncoming vehicle Ao after the blinking operation of the direction indicator 44 is resumed (see the lower part of FIG. 9). The travel control section 76 causes the subject vehicle Am to travel toward the intersecting road KR in the right-turn direction. Even when a new oncoming vehicle Ao occurs on the opposite road TR, the travel control section 76 gives priority to traveling of the subject vehicle Am. As described above, the right turn of the subject vehicle Am after giving way to the intersection vehicle Ac and the oncoming vehicle Ao in order is completed.

### (Scene 6: Scene of Prioritizing Straight Traveling of Intersection Vehicle)

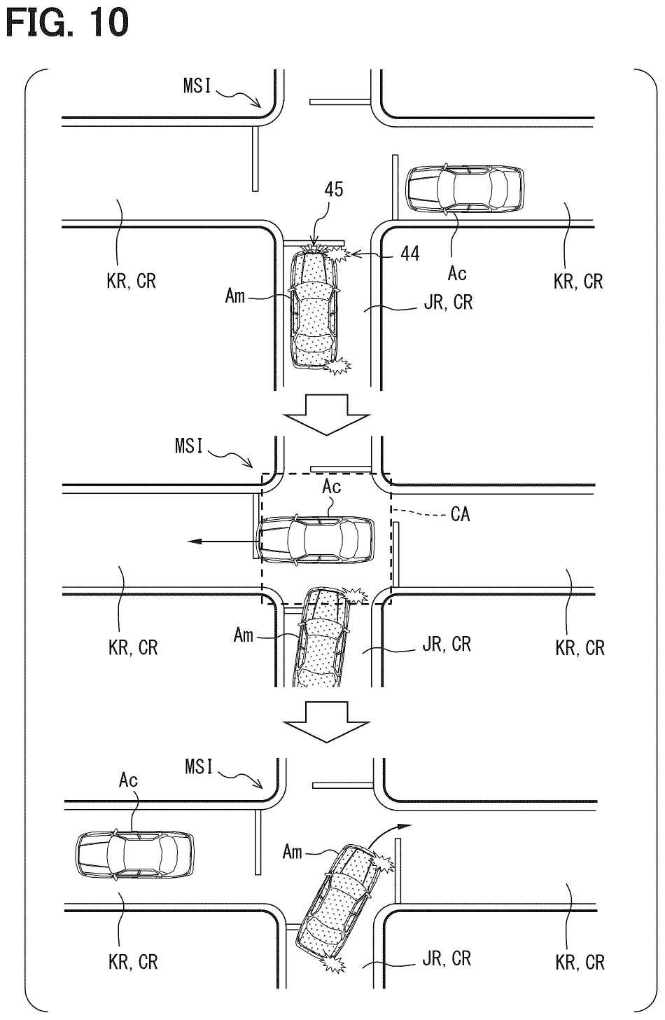

In the scene 6 illustrated in FIG. 10, the subject vehicle Am and the intersection vehicle Ac are approaching the multi-stop intersection MSI. The subject vehicle Am is scheduled to turn right at the multi-stop intersection MSI. The intersection vehicle Ac approaches the multi-stop intersection MSI from right of the subject vehicle Am. The intersection vehicle Ac is scheduled to travel straight through the multi-stop intersection MSI (see the upper part of FIG. 10).

In a case where the blinking operation of the direction indicator 144 is not detected by the another vehicle grasping section 73, the travel control section 76 performs look-in control for detecting the intersection vehicle Ac or the like after temporarily stopping the subject vehicle Am before the stop line. The travel control section 76 causes the subject vehicle Am to enter the common region CA of the multi-stop intersection MSI at a very low speed (slow down) by the look-in control (see the middle part of FIG. 10).

The travel control section 76 changes the travel control of the subject vehicle Am after the temporary stop according to the state of the intersection vehicle Ac. In a case where the intersection vehicle Ac starts to move forward prior to the subject vehicle Am, the travel control section 76 performs travel control that gives priority to the intersection vehicle Ac in parallel with the look-in control. In this case, the travel control section 76 gradually decreases the traveling speed of the subject vehicle Am. As a result, the intersection vehicle Ac can pass in front of the subject vehicle Am with a margin.

On the other hand, in a case where the standby state of the intersection vehicle Ac is continued even after the start of the look-in control, the travel control section 76 temporarily terminates the look-in control and shifts to the travel control in which the intersection vehicle Ac is prioritized. In this case, the travel control section 76 stops subject vehicle Am to urge intersection vehicle Ac to start. As described above, the intersection vehicle Ac passes through the multi-stop intersection MSI prior to the subject vehicle Am.

When the passage of the intersection vehicle Ac is confirmed by the another vehicle grasping section 73, the travel control section 76 causes the subject vehicle Am to move forward toward the right intersecting road KR (see the lower part of FIG. 10). The travel control section 76 accelerates the subject vehicle Am toward the intersecting road KR by continuing forward movement under the look-in control. As described above, the right turn of the subject vehicle Am after giving way to the intersection vehicle Ac is completed.

### (Scene 7: Scene of Change to Prioritization of Straight Traveling of Subject Vehicle)

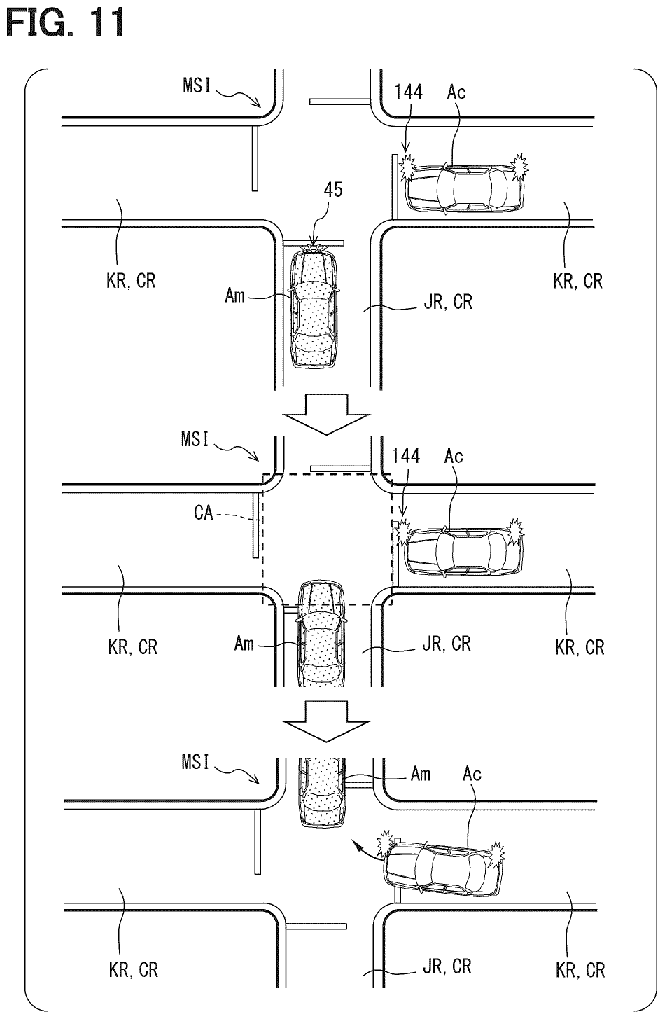

In the scene 7 illustrated in FIG. 11, the subject vehicle Am and the intersection vehicle Ac are approaching the multi-stop intersection MSI. The subject vehicle Am is scheduled to travel straight through the multi-stop intersection MSI. The intersection vehicle Ac approaches the multi-stop intersection MSI from right of the subject vehicle Am. The intersection vehicle Ac is scheduled to turn right at the multi-stop intersection MSI (see the upper part of FIG. 11).

In the scene 7, as in the scene 6 (see FIG. 10), the blinking operation of the direction indicators 144 of the intersection vehicle Ac is not detected by the subject vehicle Am that stops before the stop line. Therefore, the travel control section 76 performs the look-in control after temporarily stopping the subject vehicle Am on the stop line. In a case where the intersection vehicle Ac waits (temporarily stopped) behind the stop line, the travel control section 76 causes the subject vehicle Am to move forward by the look-in control to a position for allowing to check the operation state of the right direction indicator 144 (see the middle part of FIG. 11).

In a case where the direction indicators 144 of the intersection vehicle Ac is not capable of being confirmed in the look-in control, the another vehicle grasping section 73 may be able to estimate the traveling direction of the intersection vehicle Ac based on detection of at least one of the line-of-sight direction of the occupant of the intersection vehicle Ac or the direction of the steering wheel of the intersection vehicle Ac.

In a case where it is determined that the subject vehicle Am can travel straight by performing the look-in control, the travel control section 76 changes the control to the travel control that prioritizes traveling of the subject vehicle Am. As an example, in a case where the intersection vehicle Ac maintains the standby state, the travel control section 76 switches to give priority to traveling of the subject vehicle Am. The travel control section 76 causes the subject vehicle Am to enter the opposite road TR before the intersection vehicle Ac (see the lower part of FIG. 11). The intersection vehicle Ac turns right at the multi-stop intersection MSI so as to follow the subject vehicle Am.

### (Scene 8: Scene of Response to Another Vehicle Traveling in Unexpected Traveling Direction)

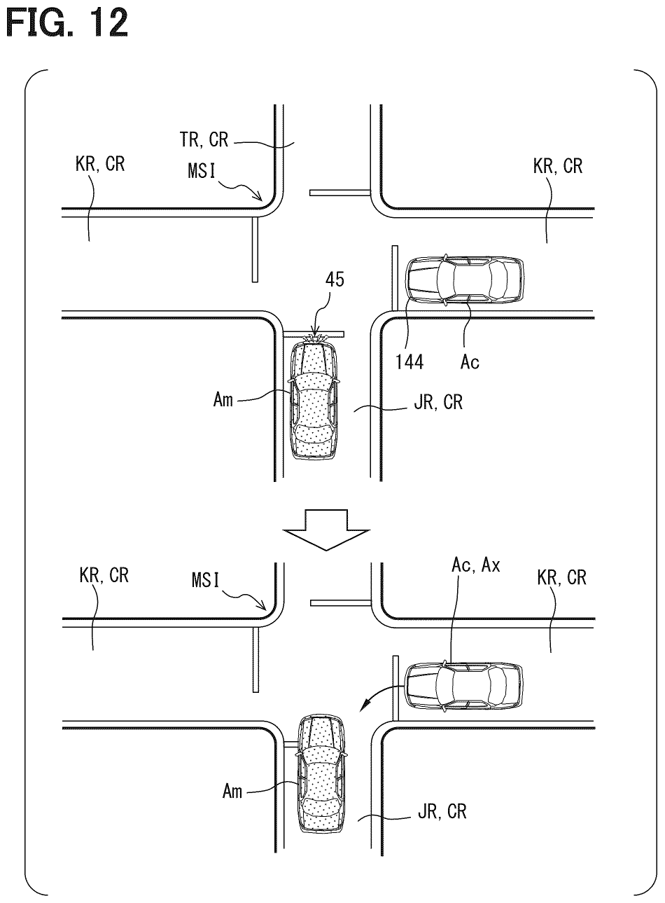

In the scene 8 illustrated in FIG. 12, the subject vehicle Am and the intersection vehicle Ac are approaching the multi-stop intersection MSI. The subject vehicle Am is scheduled to travel straight through the multi-stop intersection MSI. The intersection vehicle Ac is scheduled to turn left at the multi-stop intersection MSI. However, the intersection vehicle Ac does not blink the direction indicator 144 indicating a left turn (see the upper part of FIG. 12). The another vehicle grasping section 73 estimates the traveling direction (straight traveling direction or right turning direction) of the intersection vehicle Ac at the multi-stop intersection MSI based on the detection that the left direction indicator 144 is not blinking.

In a case where the blinking operation of the direction indicator 144 is not detected by the another vehicle grasping section 73, the travel control section 76 performs look-in control. After the start of the look-in control of the subject vehicle Am, the intersection vehicle Ac starts a left turn toward the subject vehicle road JR without activating the direction indicators 144. In this case, the another vehicle grasping section 73 detects, as a risk vehicle Ax, the intersection vehicle Ac that starts to turn right or left without activating the direction indicators 144 (see the lower part of FIG. 12).

In a case where intersection vehicle Ac starts to move in a direction (left turn direction) different from the traveling direction estimated by the intersection vehicle Ac while the subject vehicle Am is moving, the travel control section 76 sets the subject vehicle Am to the stop preparation state. Similarly, in a case where the risk vehicle Ax is detected by the another vehicle grasping section 73 while the subject vehicle Am is moving, the travel control section 76 sets the subject vehicle Am to the stop preparation state. The stop preparation state is a state in which the subject vehicle Am is capable of being immediately stopped. As an example, the travel control section 76 cooperates with the control execution section 64 to set a state (pre-feel) in which the brake pressure of the subject vehicle Am is capable of being immediately increased. In a case where the another vehicle grasping section 73 grasps excessive approach of the intersection vehicle Ac, the travel control section 76 suddenly stops the subject vehicle Am.

(Scene 9: Priority Setting Scene in a Case where all Vehicles are in Automated Driving)

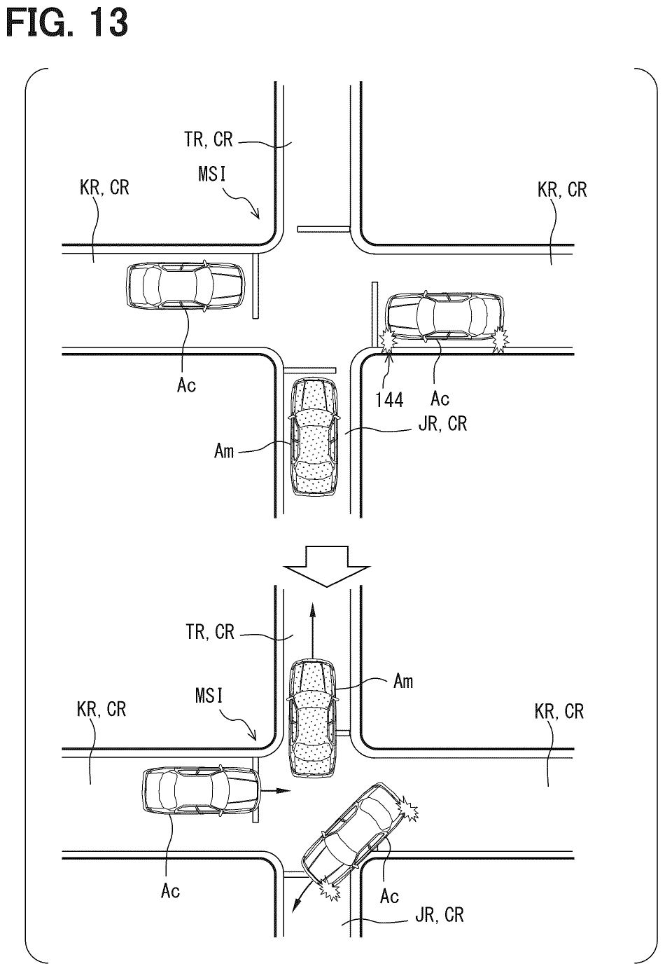

In the scene 9 illustrated in FIG. 13, the subject vehicle Am and two intersection vehicles Ac are approaching the multi-stop intersection MSI. The subject vehicle Am and each intersection vehicle Ac are all in a state where traveling is controlled by an automated driving function. In the scene 9, the road widths of the subject vehicle road JR and the opposite road TR are narrower than the road width of the intersecting road KR (see the upper part of FIG. 13).

In a case where all the vehicles approaching the multi-stop intersection MSI are in automated driving, the vehicles share information with each other via communication between the vehicles. The another vehicle grasping section 73 sets a pseudo priority relationship with each intersection vehicle Ac at the multi-stop intersection MSI for which no legal priority relationship is set. The pseudo priority relationship may be recorded in the map data of the map DB 36 as information dedicated to the automated driving vehicle, or may be determined in the vicinity of the multi-stop intersection MSI via communication between vehicles. According to such arbitration between vehicles, for example, the priority of the vehicle traveling on the connection road CR having a narrow road width is set to be high.

The travel control section 76 causes the subject vehicle Am to travel based on the priority relationship set with the another vehicle (intersection vehicle Ac) by the another vehicle grasping section 73. In the scene 9 where the road width of the subject vehicle road JR is narrower than the road width of the intersecting road KR, the travel control section 76 performs travel control that gives priority to the movement of the subject vehicle Am.

The travel control section 76 causes the subject vehicle Am to start toward the intersecting road KR before the intersection vehicle Ac and passes through the multi-stop intersection MSI. After the subject vehicle Am passes through, the right intersection vehicle Ac turns left toward the subject vehicle road JR having a vacant space. Further, the left intersection vehicle Ac goes straight toward the right intersecting road KR having a vacant space (see the lower part of FIG. 13).

Further, the another vehicle grasping section 73 can acquire the another vehicle information indicating the position information and the traveling direction of the intersection vehicle Ac or the oncoming vehicle Ao (see FIG. 3) by reception at a timing sufficiently distant to the multi-stop intersection MSI. The travel control section 76 determines whether the arrival timing of the other vehicle at the multi-stop intersection MSI overlaps that of the subject vehicle Am based on the another vehicle information acquired by the another vehicle grasping section 73.

In a case where the arrival timing of the other vehicles overlaps that of the subject vehicle Am, the travel control section 76 controls traveling of the subject vehicle Am so that the other vehicles can be avoided before the multi-stop intersection MSI. As an example, the travel control section 76 sets a standby position in a section (hereinafter, section before the narrow road) in which a road width before the subject vehicle road JR is a narrow road is secured, and causes the subject vehicle Am to wait before entering the narrow road. As a result, the subject vehicle Am can pass another vehicle in a section before the narrow road, having a sufficient road width.

### (Details of Travel Control Process at Multi-Stop Intersection)

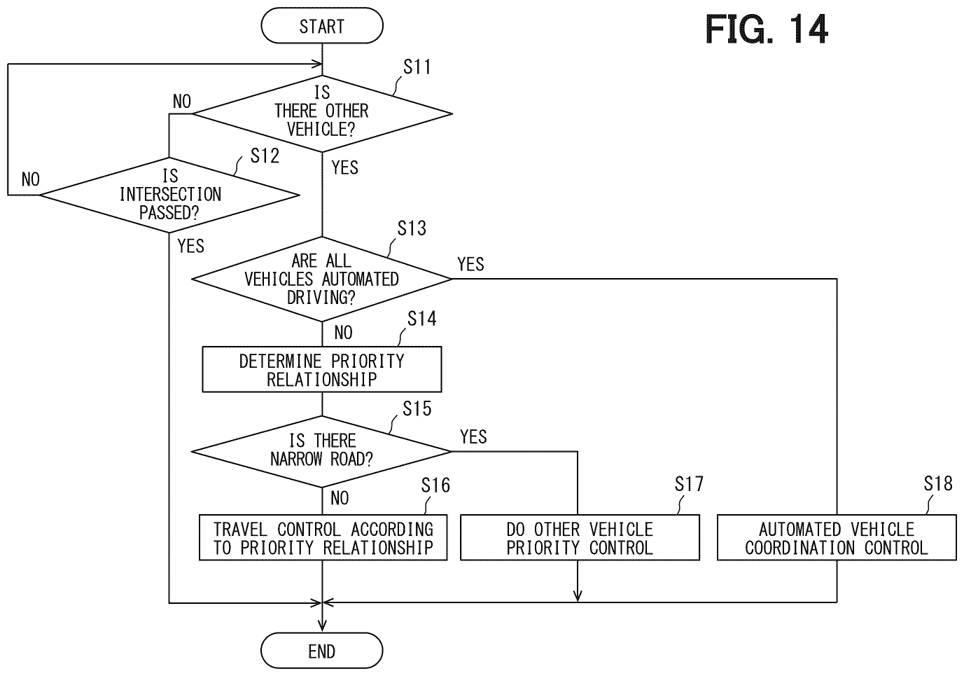

Next, details of the travel control process executed by the automated driving ECU 50 in order to realize the travel control at the multi-stop intersection MSI described above will be described below with reference to FIGS. 1 to 13 based on FIGS. 14 to 18. The main process illustrated in FIG. 14 is started by the automated driving ECU 50 on condition that the subject vehicle Am approaches the multi-stop intersection MSI by a predetermined distance (for example, about 1 km).

In S11 of the main process, the another vehicle grasping section 73 determines whether another vehicle approaching the multi-stop intersection MSI in front of the subject vehicle is present. In a case where another vehicle is not present (S11: NO), in S12, the road grasping section 74 determines whether the subject vehicle has passed through the multi-stop intersection MSI. In a case where the subject vehicle Am has passed through the multi-stop intersection MSI (S12: YES), the main process is terminated. On the other hand, in a case where the subject vehicle Am has not passed through the multi-stop intersection MSI (S12: NO), grasping of another vehicle is continued.

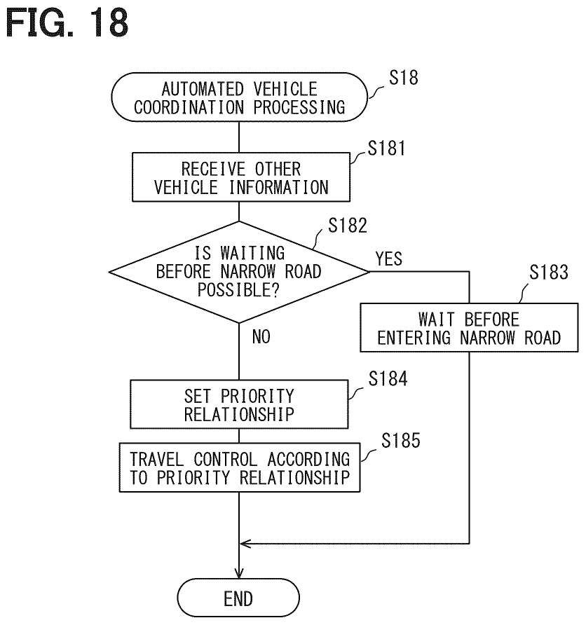

When another vehicle approaching the multi-stop intersection MSI is grasped (S11: YES), the another vehicle grasping section 73 determines whether the another vehicle is an automated driving vehicle that travels by the automated driving function in S13. The another vehicle may be traveling by driving assistance control or may be traveling by autonomous travel control. In a case where all the other vehicles are traveling by the automated driving function (S13: YES), the travel control section 76 performs the automated driving vehicle handling control (see FIG. 18) in S18.

In a case where the other vehicles include a vehicle that is in manual driving, the another vehicle grasping section 73 determines the priority relationship between the subject vehicle Am and the other vehicles in S14. As described above, the another vehicle grasping section 73 determines the priority relationship between the subject vehicle Am and the another vehicle based on the timing of reaching the multi-stop intersection MSI or the relative positional relationship.

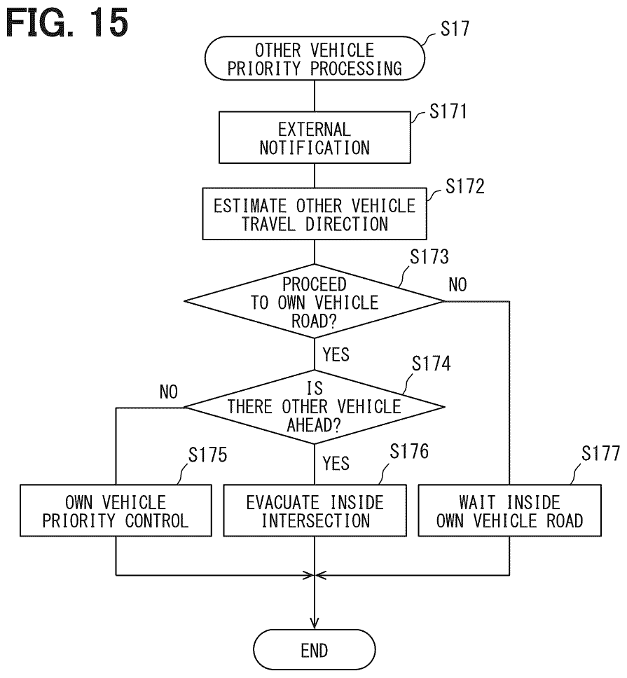

In S15, the road grasping section 74 determines whether the connection road CR connected to the multi-stop intersection MSI is a narrow road on which it is difficult for the subject vehicle Am and another vehicle to pass each other. In a case where at least one connection road CR is a narrow road (S15: YES), the travel control section 76 performs travel control (hereinafter, another vehicle priority control, see FIG. 15) in which traveling of another vehicle is prioritized in S17. On the other hand, in a case where no connection roads CR are narrow roads (S15: NO), the travel control section 76 performs travel control according to the priority relationship in S16. The process of S14 for determining the priority relationship may be performed only in a case where it is determined that no connection roads CR are narrow roads (S15: NO).

In S171 of the process for the another vehicle priority control (hereinafter, another vehicle priority process) illustrated in FIG. 15, the out-of-vehicle notification using the out-of-vehicle notification device 45 is made for the another vehicle or the like. The out-of-vehicle notification by the out-of-vehicle notification device 45 may be omitted according to the relative position of another vehicle. For example, in a case where the out-of-vehicle notification device 45 has a configuration that is difficult to visually recognize from the side, the out-of-vehicle notification may be omitted in a case where the oncoming vehicle Ao is not present.

In S172, the another vehicle grasping section 73 estimates the traveling direction of the another vehicle at the multi-stop intersection MSI. The another vehicle grasping section 73 estimates the traveling direction of the another vehicle based on the information about the blinking operation and the non-operation of the direction indicator 144. In S172, look-in control for detecting the direction indicators 144 of the intersection vehicle Ac may be performed after the temporary stop.

In S173, the another vehicle grasping section 73 determines whether the another vehicle is scheduled to proceed to the subject vehicle road JR. In S173, it is determined whether the subject vehicle Am obstructs traveling of another vehicle. In a case where the another vehicle is not scheduled to proceed to the subject vehicle road JR (S173: NO), the travel control section 76 performs another vehicle priority control of causing the subject vehicle Am to wait on the subject vehicle road JR in S177 (see scene 1 in FIG. 3 and scene 6 in FIG. 10).

In a case where the another vehicle travels in the traveling scheduled direction of the subject vehicle Am, the travel control section 76 starts the subject vehicle Am so that the subject vehicle Am follows the another vehicle. In addition, in a case where the standby state for giving priority to another vehicle continues for more than a predetermined time, the travel control section 76 terminates the standby state and starts the subject vehicle Am (see scene 7 in FIG. 11 and the like).

In a case where the another vehicle is scheduled to travel to the subject vehicle road JR (S173: YES), the another vehicle grasping section 73 determines whether another vehicle is present on the connection road CR of travel destination of the subject vehicle Am in S174. In a case where another vehicle is not present in the travel destination of the subject vehicle Am (S174: NO), the travel control section 76 causes the subject vehicle Am to travel ahead of the another vehicle in S175 to evacuate the subject vehicle Am from the subject vehicle road JR. By such subject vehicle preceding control, the subject vehicle Am passes through the multi-stop intersection MSI earlier than the another vehicle.

In a case where another vehicle is present at the travel destination of the subject vehicle Am (S174: YES), the travel control section 76 moves the subject vehicle Am obstructing traveling of the another vehicle to a standby position at which traveling of the another vehicle in S176 is not obstructed (see the scenes 2 and 7 in FIG. 5 and the scenes 4 and 5 in FIG. 8). The travel control section 76 causes the subject vehicle Am to wait at a standby position set to include the common region CA of the multi-stop intersection MSI. After the another vehicle moves to the subject vehicle road JR, the travel control section 76 causes the subject vehicle Am to enter the scheduled traveling destination connection road CR.

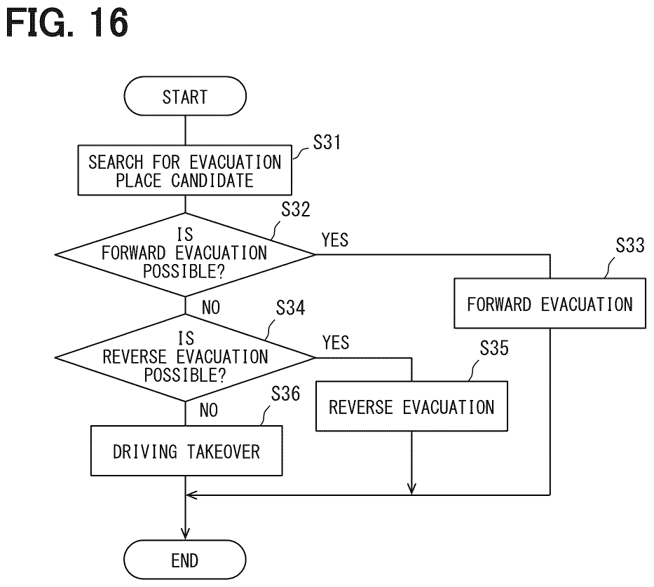

The emergency evacuation process illustrated in FIG. 16 is started by the automated driving ECU 50 in a case where another vehicle trying to forcibly travel to the subject vehicle road JR occurs at the multi-stop intersection MSI (see scene 3 in FIG. 6).

In S31 of the emergency evacuation process, the candidate for the evacuation place where the subject vehicle Am is allowed to be evacuated is searched for by the road grasping section 74. Based on the search result in S31, the travel control section 76 determines whether evacuation by forward movement is possible in S32. In a case where the evacuation place ahead is searched for and the vehicle can move to the evacuation place (S32: YES), the travel control section 76 performs the movement (evacuation) to the evacuation place ahead in S33.

In a case where there is no evacuation place in front of the subject vehicle (S32: NO), the travel control section 76 determines whether evacuation in backward movement is possible in S34. In a case where the evacuation place behind is searched for and the vehicle can move to the evacuation place (S34: YES), the travel control section 76 performs movement (evacuation) to the evacuation place behind in S35.

In a case where there is no evacuation place in front of or behind the subject vehicle Am (S34: NO), the control switching section 75 executes the driving-mode switch from the automated driving function to the driving operator (driver) in S36. Here, in a case where the subject vehicle Am is a remotely operated vehicle, a driving-mode switch in which the remote operation operator at the management center is a driving operator may be performed in S36.

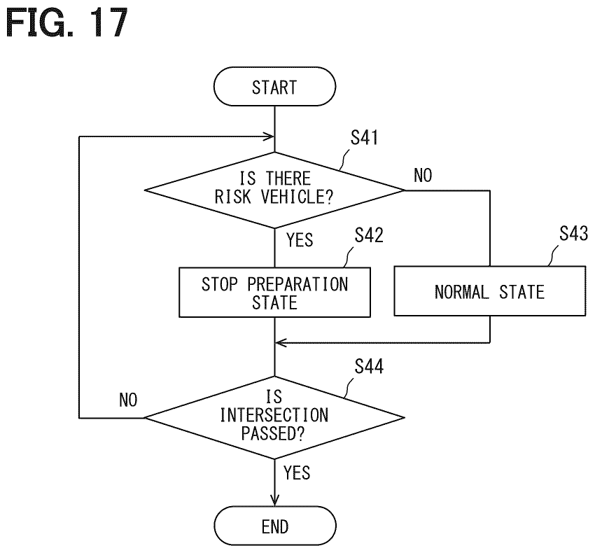

The stop preparation process illustrated in FIG. 17 is started by the automated driving ECU 50 based on the start of entry to the common region CA of the multi-stop intersection MSI. In step S41 of the stop preparation process, it is determined whether there is the risk vehicle Ax (see scene 8 in FIG. 12) that starts a right or left turn without activating the direction indicators 144. In S41, the another vehicle grasping section 73 may detect, as the risk vehicle Ax, another vehicle that starts moving in a direction different from the traveling direction estimated from the operation status of the direction indicator 144.

In a case where the risk vehicle Ax is detected by the another vehicle grasping section 73 (S41: YES), the travel control section 76 sets the subject vehicle Am to a stop preparation state where the subject vehicle Am is capable of being immediately stopped in S42. On the other hand, in a case where the risk vehicle Ax is not detected by the another vehicle grasping section 73 (S41: NO), the travel control section 76 does not shift to the stop preparation state and maintains the normal state (S43). The travel control section 76 continues switching between the stop preparation state and the normal state until the subject vehicle Am passes through the multi-stop intersection MSI (S44: NO). When the subject vehicle Am passes through the multi-stop intersection MSI (S44: YES), the stop preparation processing is terminated.

In S181 of the process for the automated driving vehicle handling control (hereinafter, automated driving vehicle handling process) illustrated in FIG. 18, the another vehicle grasping section 73 acquires another vehicle information indicating the position and the traveling direction of the another vehicle traveling by the automated driving function by communication. In S182, the travel control section 76 determines whether it is possible to cause the subject vehicle Am to wait in the section before the narrow road before the subject vehicle road JR is the narrow road. In a case where standby in the section before the narrow road is possible (S182: YES), the travel control section 76 sets a standby position in the section before the narrow road in S183. The travel control section 76 waits for passage of another vehicle at the set standby position as travel control that prioritizes traveling of another vehicle.

In a case where standby in the section before the narrow road is not possible (S182: NO), the another vehicle grasping section 73 sets a pseudo priority relationship with another vehicle traveling by the automated driving function in S184. The pseudo priority relationship is shared among all vehicles. In S185, the travel control section 76 performs travel control according to the priority relationship shared with another vehicle. As an example, in a case where the subject vehicle Am is traveling on the connection road CR having a narrower road width than another vehicle, the movement of the subject vehicle Am is prioritized (see scene 9 in FIG. 13)

### Overview of First Embodiment

In the first embodiment described so far, in a case where the connection road CR connected to the multi-stop intersection MSI is a narrow road, travel control that gives priority to traveling of another vehicle is performed. Therefore, the subject vehicle Am can smoothly travel through the multi-stop intersection MSI in a state where another vehicle is caused to go first and the subject vehicle is not obstructed by the another vehicle. As a result, the convenience of the automated driving at the multi-stop intersection MSI can be secured.

In addition, in the first embodiment, the traveling direction of another vehicle at the multi-stop intersection MSI is estimated. In a case where the subject vehicle Am obstructs traveling of another vehicle, the travel control section 76 moves the subject vehicle Am to a standby position where the subject vehicle Am does not obstruct traveling of another vehicle. According to such travel control, both the subject vehicle Am and the another vehicle can smoothly travel through the multi-stop intersection MSI.

In the first embodiment, in a case where the standby position is not allowed to be set on the connection road CR (subject vehicle road JR), the standby position is set in the common region CA of the multi-stop intersection MSI. In the common region CA, even when the connection road CR is a narrow road, a space where the vehicles are allowed to pass each other is easily secured. As a result, the subject vehicle Am and the another vehicle can smoothly travel through the multi-stop intersection MSI.

Furthermore, in the first embodiment, the standby position is set at a position closer to the surrounding road shoulder than the center of the multi-stop intersection MSI. According to such setting of the standby position, even when the subject vehicle Am waits at the standby position in the common region CA, another vehicle can pass by the side of the subject vehicle Am. Therefore, the subject vehicle Am and the another vehicle can smoothly travel through the multi-stop intersection MSI.

In addition, in the first embodiment, in a case where the oncoming vehicle Ao is estimated to move to the connection road CR different from the subject vehicle road JR, the travel control section 76 causes the subject vehicle Am to wait on the subject vehicle road JR. By such standby of the subject vehicle Am, the oncoming vehicle Ao can travel through the multi-stop intersection MSI. On the other hand, in a case where the oncoming vehicle Ao is estimated to move to the subject vehicle road JR, the travel control section 76 causes the subject vehicle Am to wait at the multi-stop intersection MSI. By the movement of the subject vehicle Am to the multi-stop intersection MSI, a space where the oncoming vehicle Ao can travel can be secured in the subject vehicle road JR. As a result, the subject vehicle Am and the oncoming vehicle Ao can smoothly travel through the multi-stop intersection MSI.

In the first embodiment, in a case where it is estimated that the intersection vehicle Ac located on the intersecting road KR on which the subject vehicle Am is scheduled to turn right or left will move to the subject vehicle road JR, the travel control section 76 causes the subject vehicle Am to leave the subject vehicle road JR. After the intersecting road KR moves to the subject vehicle road JR, the travel control section 76 causes the subject vehicle Am to enter the intersecting road KR. According to such control, it is possible to give way to the intersection vehicle Ac even in a scene where the subject vehicle Am and the intersection vehicle Ac obstruct each other in the traveling direction (see scene 4 in FIG. 7). As a result, both the subject vehicle Am and the intersection vehicle Ac can smoothly travel through the multi-stop intersection MSI.

Furthermore, in the first embodiment, the arrival timing of another vehicle at the multi-stop intersection MSI is estimated. Even when the subject vehicle Am reaches the multi-stop intersection MSI earlier than the another vehicle, the travel control section 76 causes the another vehicle estimated to reach the multi-stop intersection MSI within a predetermined time to travel the multi-stop intersection MSI preferentially. According to such control, it is possible to appropriately give way to another vehicle having a later arrival timing.

In addition, in the first embodiment, in a case where a standby state for giving priority to another vehicle continues for more than a predetermined time, the standby state is terminated. According to such control, it is possible to avoid occurrence of a situation in which the vehicles are in a state of cautious observation and cannot start each other.

In the first embodiment, in a case where another vehicle travels in the traveling scheduled direction of the subject vehicle Am, the travel control section 76 starts the subject vehicle Am so that the subject vehicle Am follows the another vehicle. According to such follow-up control, the subject vehicle Am can smoothly leave the multi-stop intersection MSI so as not to obstruct another vehicle that newly arrives at the multi-stop intersection MSI.

Further, the device control section 65 of the first embodiment notifies the outside of the vehicle that the subject vehicle Am is traveling by the automated driving function at the multi-stop intersection MSI using the out-of-vehicle notification device 45. According to such out-of-vehicle notification, the driver of the another vehicle can easily recognize that the subject vehicle Am has given a way. As a result, the subject vehicle Am and the another vehicle can smoothly pass through the multi-stop intersection MSI combined with the travel control of the subject vehicle Am that prioritizes the traveling of the another vehicle.

In addition, in the first embodiment, in a case where the connection road CR is a narrow road, the travel control section 76 performs look-in control in which the subject vehicle Am enters the multi-stop intersection MSI in order to detect the intersection vehicle Ac after temporarily stopping the subject vehicle Am. According to the above, the another vehicle grasping section 73 can more reliably acquire information for estimating the traveling direction of the another vehicle.

In the first embodiment, the travel control of the subject vehicle Am is changed according to the state of the intersection vehicle Ac. Thus, the travel control section 76 appropriately switches the stop and the start of the subject vehicle Am in accordance with the state of the intersection vehicle Ac to enable smooth passage through the multi-stop intersection MSI.

Further, in the first embodiment, in a case where the intersection vehicle Ac is in the standby state, the travel control section 76 shifts from the look-in control to the travel control that gives priority to the intersection vehicle Ac. Such a change in travel control enables smooth giving way to the intersection vehicle Ac in the standby state.

In addition, in the first embodiment, in a case where the intersection vehicle Ac moves forward ahead of the subject vehicle Am, the travel control section 76 performs travel control that gives priority to the intersection vehicle Ac in parallel with the look-in control. With such continuation of the look-in control, the subject vehicle Am can grasp the situation of the intersecting road KR while giving way to the intersection vehicle Ac. As a result, after passing through the intersection vehicle Ac, the travel control section 76 can quickly shift from the look-in control to the normal travel control.

In addition, in the first embodiment, in the look-in control, the travel control section 76 causes the subject vehicle Am moves forward to a position for allowing to confirm the direction indicator 144 of the intersection vehicle Ac. According to such look-in control, the another vehicle grasping section 73 can more reliably acquire information for estimating the traveling direction of the another vehicle.

Further, in the first embodiment, in the look-in control, in a case where the direction indicators 144 of the intersection vehicle Ac is not capable of being confirmed, the another vehicle grasping section 73 acquires at least one detection result of the line-of-sight direction of the occupant of the intersection vehicle Ac or the direction of the steering wheel of the intersection vehicle Ac. The another vehicle grasping section 73 estimates the traveling direction of the another vehicle at the multi-stop intersection MSI based on the detection result of the line-of-sight direction or the direction of the steering wheel. Using such a detection result, the traveling direction of another vehicle can be estimated in more scenes.

In addition, in the first embodiment, in a case where another vehicle enters the subject vehicle road JR, the road grasping section 74 determines whether there is an evacuation place where the subject vehicle Am is allowed to be evacuated in front of or behind the subject vehicle Am. In a case where there is an evacuation place, the travel control section 76 moves the subject vehicle Am to the evacuation place. According to such evacuation control, even in a scene where another vehicle forcibly enters the subject vehicle road JR (see scene 3 in FIG. 6), the subject vehicle Am and the another vehicle can continue traveling without being stopped on the narrow road.

In the first embodiment, in a case where there are the evacuation places in front of and behind the subject vehicle Am, the travel control section 76 moves the subject vehicle Am to the evacuation place in front of the subject vehicle Am. In general, the detection capability of the surroundings monitoring sensor 30 is higher in the forward range than in the backward range. Therefore, according to the control that prioritizes evacuation to the evacuation place ahead, the subject vehicle Am can move more smoothly in the evacuation place.

Further, in the first embodiment, in a case where there is no evacuation place in front of or behind the subject vehicle Am, the control switching section 75 performs the driving-mode switch from the automated driving function to the driving operator such as the driver. As a result, in a case where handling by the automated driving function has a difficulty, it is possible to transfer the authority at an appropriate timing and leave the handling to the driver.

In addition, in the first embodiment, the evacuation place is set in a range including the road shoulder of the subject vehicle road JR. Therefore, even in a case where the subject vehicle road JR is a narrow road, an evacuation place can be set in the subject vehicle road JR. As a result, the subject vehicle Am and another vehicle are allowed to pass each other in the subject vehicle road JR which is a narrow road.

In the first embodiment, in a case where another vehicle starts to move in a direction different from the estimated traveling direction while the subject vehicle Am is moving, the travel control section 76 sets the subject vehicle Am to the stop preparation state where the subject vehicle Am can be immediately stopped. Thus, for example, in a case where a sudden approach of another vehicle to the subject vehicle Am is detected, the travel control section 76 can quickly stop the subject vehicle Am.

Furthermore, in the first embodiment, another vehicle that starts turning right or left without activating the direction indicators 144 is grasped as the risk vehicle Ax. In a case where the risk vehicle Ax is grasped while the subject vehicle Am is moving, the travel control section 76 sets the subject vehicle Am to the stop preparation state. Thus, for example, in a case where a sudden approach of another vehicle to the subject vehicle Am is detected, the travel control section 76 can quickly stop the subject vehicle Am.

In addition, in the first embodiment, the another vehicle information indicating the position and the traveling direction of the another vehicle traveling by the automated driving function is acquired by communication. In a case where the another vehicle information is acquired in front of the multi-stop intersection MSI, the travel control section 76 starts travel control that prioritizes traveling of the another vehicle on the subject vehicle road JR in front of the multi-stop intersection MSI. According to the above, the subject vehicle Am and the another vehicle can pass each other in the section before the narrow road or the like before the road width is narrowed.

In the first embodiment, at the multi-stop intersection MSI for which no legal priority relationship is set, the another vehicle grasping section 73 sets a pseudo priority relationship with another vehicle traveling by the automated driving function. As a result, the subject vehicle Am and the another vehicle that are both in automated driving can smoothly travel through the multi-stop intersection MSI without interfering with each other according to the shared priority relationship.

Furthermore, in the first embodiment, in a case where the another vehicle is traveling by the automated driving function, the travel control section 76 gives priority to one of the subject vehicle Am and the another vehicle, the one being traveling on the connection road CR having a narrow road width. According to the above, the vehicle traveling on the narrow connection road CR preferentially leaves the connection road CR. As a result, a situation in which traffic at the multi-stop intersection MSI is congested can be avoided.

In the first embodiment described above, the device control section 65 corresponds to an “out-of-vehicle notification control section”, the another vehicle grasping section 73 corresponds to an “another vehicle determination section”, the road grasping section 74 corresponds to a “road determination section”, and the common region CA corresponds to an “(intersection) area”. The automated driving ECU 50 corresponds to an “automated driving control device”.

### Second Embodiment

The second embodiment of the present disclosure is a modification of the first embodiment. In a case where the subject vehicle Am is scheduled to travel through the multi-stop intersection MSI, the automated driving ECU 50 according to the second embodiment stops the autonomous travel control being performed. Before the subject vehicle Am reaches the multi-stop intersection MSI, the automated driving ECU 50 cooperates with the HMI system 10 to make a notification of making a request of the driver for a driving-mode switch or surroundings monitoring. On the other hand, at the non-multi-stop intersection, continuation of the autonomous travel control is permitted. As an example, an intersection where traffic signals are installed is a non-multi-stop intersection.

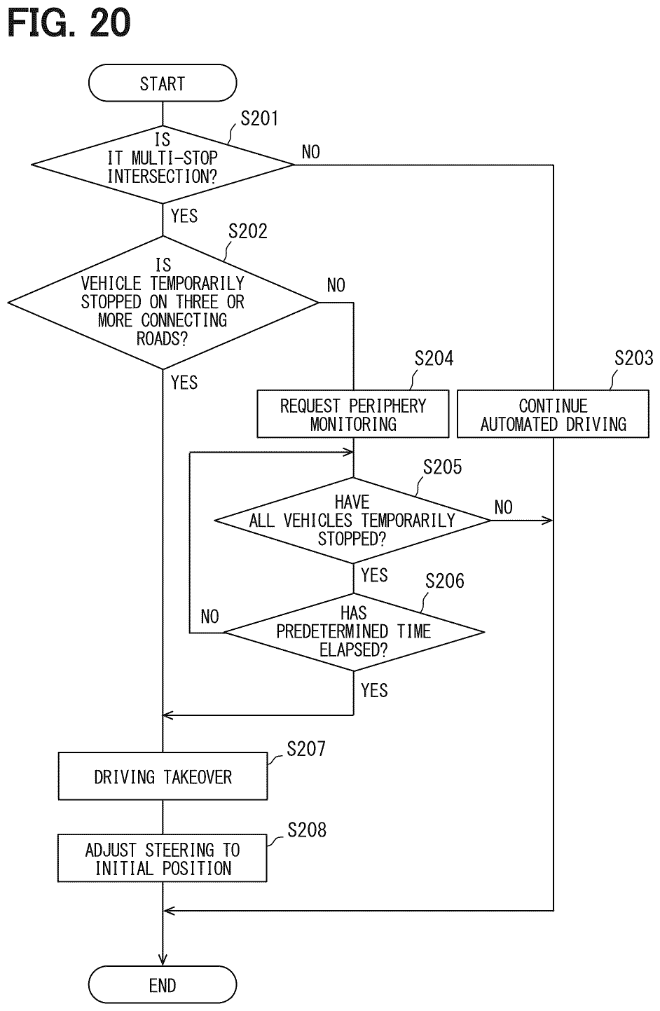

Hereinafter, details of the travel control process performed by the automated driving ECU 50 of the second embodiment will be described with reference to FIGS. 1, 2, and 19 based on FIG. 20. As in the first embodiment, the travel control process illustrated in FIG. 20 is started by the automated driving ECU 50 on condition that the subject vehicle Am approaches the multi-stop intersection MSI by a predetermined distance (for example, about 1 km).

In S201 of the travel control process, the road grasping section 74 determines whether the preceding intersection through which the subject vehicle Am traveling by the autonomous travel control is scheduled to pass is the multi-stop intersection MSI. In a case where the preceding intersection is not the multi-stop intersection MSI (S201: NO), the control switching section 75 permits continuation of traveling by the autonomous travel control (fully automated driving) in S203. As a result, the subject vehicle Am continues traveling by the autonomous travel control without the surroundings monitoring obligation.

In a case where the preceding intersection is the multi-stop intersection MSI (S201: YES), the another vehicle grasping section 73 grasps another vehicle stopping before the stop line of each connection road CR. In S202, the another vehicle grasping section 73 determines whether the vehicles are temporarily stopped on the connection roads CR in three or more directions including the subject vehicle Am, in other words, whether other vehicles are temporarily stopped on two or more connection roads CR.

In a case where the connection roads CR on which the vehicles are temporarily stopped are less than three directions (two directions or less), the control switching section 75 determines to suspend the autonomous travel control in S204. Based on the determination in S207, the notification request section 72 outputs an execution request for a notification of requesting the start of the surroundings monitoring to the HCU 100. As a result, the control state of the subject vehicle Am is switched from the autonomous travel control to the driving assistance control in which the driver is obliged to monitor the surroundings.

In S205, the another vehicle grasping section 73 determines whether all the vehicles scheduled to enter the multi-stop intersection MSI continue the temporary stop. In a case where other vehicles (the oncoming vehicle Ao or the intersection vehicle Ac) start to move (S205: NO), the subject vehicle Am gives priority to traveling of all the other vehicles, and then travels through the multi-stop intersection MSI under the driving assistance control with the surroundings monitoring obligation.

In a case where all the other vehicles continue the temporary stop (S205: YES), the control switching section 75 determines whether the elapsed time after the temporary stop of the other vehicles together with the subject vehicle Am has exceeded a predetermined time (for example, about 5 to 10 seconds) in S206. In a case where the predetermined time has not elapsed (S206: NO), the control switching section 75 waits for the start of the other vehicles.

On the other hand, in a case where the other vehicles do not start for the predetermined time or more (S206: YES), the control switching section 75 determines the driving-mode switch to the driver in S207. Based on the determination in S207, the notification request section 72 outputs, to the HCU 100, an execution request for a notification of requesting the driving-mode switch, in other words, an execution request for a notification of requesting the start of the driving operation. As a result, the control state of the subject vehicle Am is further switched from the driving assistance control to the manual driving by the driver.

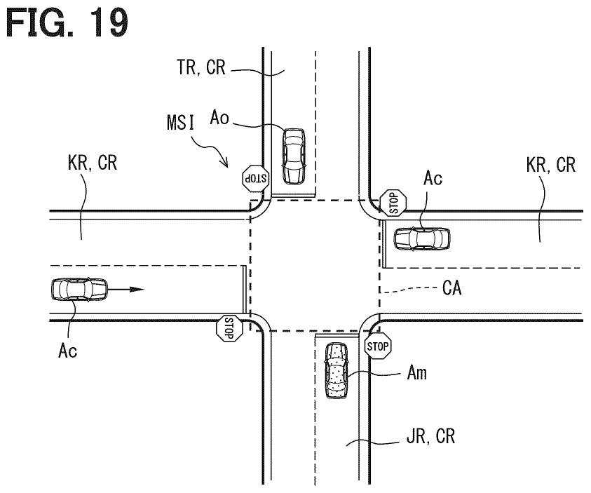

On the other hand, in a case where the vehicles are temporarily stopped on the connection roads CR in three or more directions (S202: YES, see FIG. 19), the control switching section 75 determines the termination of the autonomous travel control, that is, the driving-mode switch to the driver in S207. Based on the determination in S207, the notification request section 72 outputs, to the HCU 100, an execution request for a notification of requesting a driving-mode switch, in other words, an execution request for a notification of requesting start of surroundings monitoring and a driving operation. As a result, the control state of the subject vehicle Am is further switched from the autonomous travel control to the manual driving by the driver.

In a case where the driving-mode switch to the manual driving by the driver is performed, the travel control section 76 cooperates with the control execution section 64 and the travel control ECU 40 to perform control of returning the direction of the steering wheel of the subject vehicle Am to a predetermined initial position in S208. As a result, at the timing of the driving-mode switch, the steering angle (steering wheel angle) of the subject vehicle Am intentionally approaches zero degree (straight traveling state). Even in a case where the subject vehicle Am is scheduled to turn right or left at the multi-stop intersection MSI, the travel control section 76 performs control of returning the direction of the steering wheel to the initial position. As a result, even after the automated steering for turning right or left is performed, the driver performs the steering operation again when the driving-mode switch occurs. The process of S208 for adjusting the posture of the subject vehicle Am may be started or completed before the driving-mode switch process of S207.

### Overview of Second Embodiment

In the second embodiment described so far, in a case where the preceding intersection through which the subject vehicle Am traveling by the autonomous travel control where the driver is not obliged to monitor the surroundings is scheduled to pass is the multi-stop intersection MSI, the autonomous travel control is terminated. According to such a planned driving-mode switch, the subject vehicle Am can smoothly travel through the multi-stop intersection MSI. On the other hand, in a case where the preceding intersection is not the multi-stop intersection MSI, continuation of traveling by the autonomous travel control is permitted. As a result, the convenience of the automated driving at the multi-stop intersection MSI can be secured.

In addition, in the second embodiment, in a case where other vehicles scheduled to enter the multi-stop intersection MSI are temporarily stopped on two or more of the connection roads CR connected to the multi-stop intersection MSI, the control switching section 75 switches the control state of the subject vehicle Am from the autonomous travel control to the manual driving. Therefore, in a complex scene, the control right of the subject vehicle Am can be appropriately transferred to the driver.

In the second embodiment, in a case where another vehicle scheduled to enter the multi-stop intersection MSI temporarily stops together with the subject vehicle Am and then does not start for a predetermined time or more, the control switching section 75 switches the control state of the subject vehicle Am to manual driving by the driver. According to such control, it is possible to avoid occurrence of a situation in which vehicles temporarily stopped at the multi-stop intersection MSI are in a state of cautious observation and cannot start to travel.

Furthermore, in the second embodiment, in a case where the driving-mode switch to the manual driving by the driver is performed, the travel control section 76 performs control of returning the direction of the steering wheel of the subject vehicle Am to a predetermined initial position. Thus, the driver can start the steering operation from the initial position. Therefore, a situation in which it is difficult to grasp the steering angle at the time of the driving-mode switch and the driving operation cannot be immediately started can be avoided.

In addition, in the second embodiment, in a case where the subject vehicle Am is scheduled to turn right or left at the multi-stop intersection MSI, the travel control section 76 performs control of returning the direction of the steering wheel to the initial position. Thus, the driver can perform a steering operation necessary for turning right or left after the start of the driving operation. As a result, it is possible to perform a smooth driving-mode switch from the driving assistance control or the autonomous travel control to the driver.

### Third Embodiment

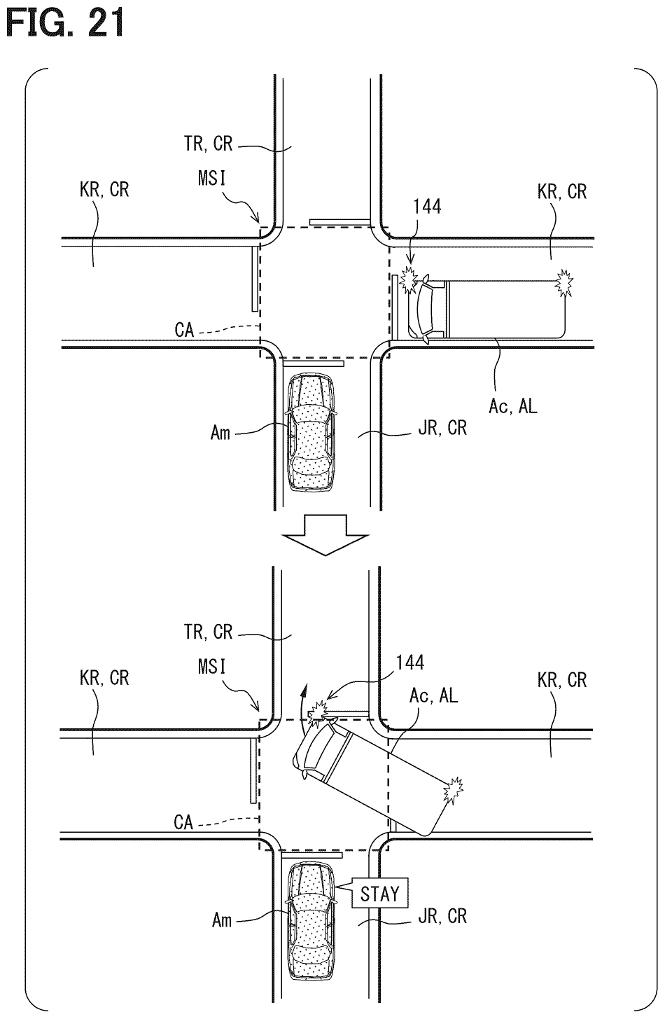

The third embodiment of the present disclosure is another modification of the first embodiment. As in the scenes 1 to 9 of the first embodiment, the automated driving ECU 50 according to the third embodiment performs control related to traveling of the multi-stop intersection MSI in the scenes 10 to 16 to be described later. Hereinafter, details of the travel control performed by the automated driving ECU 50 in the scenes 10 to 16 of the third embodiment will be described with reference to FIGS. 1 and 2 based on FIGS. 21 to 28.

### (Scenes 10 and 11: Right or Left Turning Priority Scene of Large Vehicle)

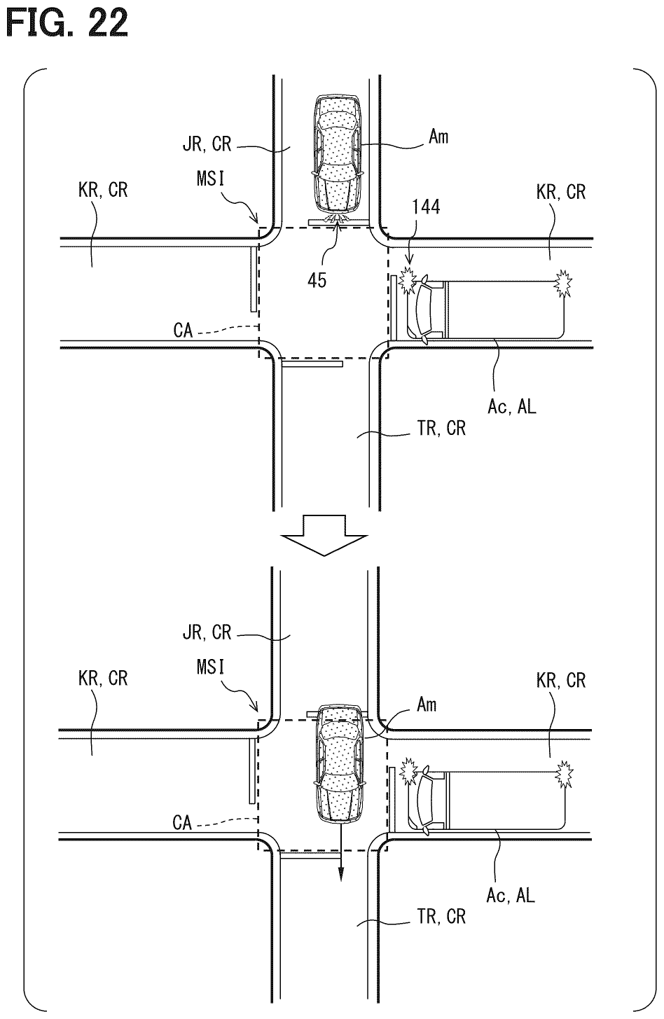

In the scene 10 illustrated in FIG. 21 and the scene 11 illustrated in FIG. 22, the subject vehicle Am and the intersection vehicle Ac are approaching the multi-stop intersection MSI. The subject vehicle Am is scheduled to travel straight through the multi-stop intersection MSI. The intersection vehicle Ac is, for example, a large vehicle AL larger in size than the subject vehicle Am, such as a bus, a truck, or a crane vehicle. The large vehicle AL blinks the left direction indicator 144, and is scheduled to turn right at the multi-stop intersection MSI. In the scene 10, the subject vehicle Am is scheduled to proceed beyond a right turn of the large vehicle AL. On the other hand, in scene 11, the subject vehicle road JR where the subject vehicle Am is located is beyond a right turn of the large vehicle AL.

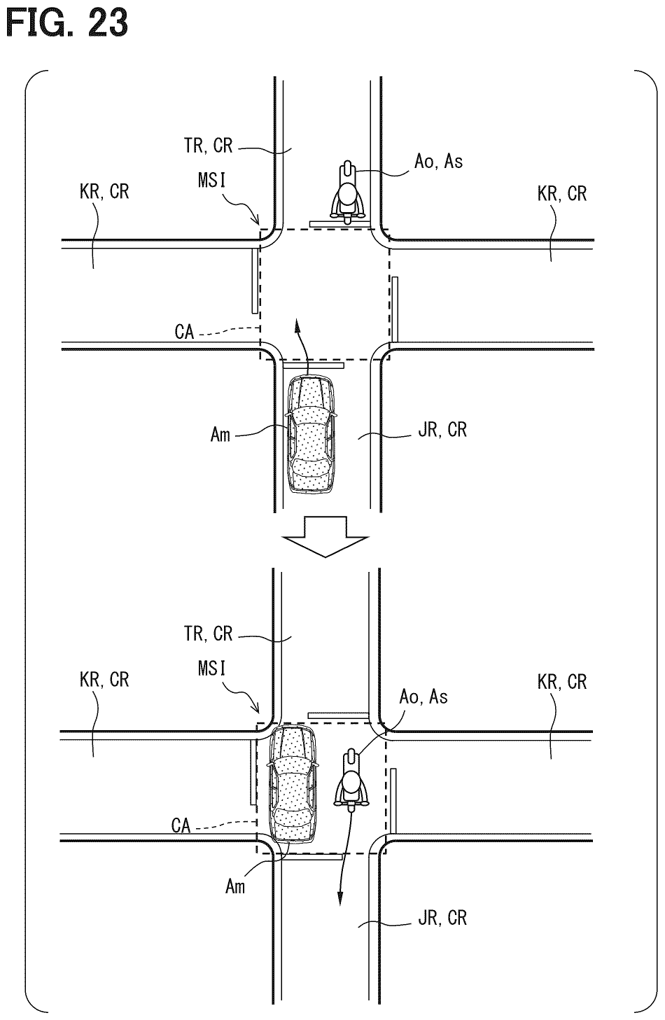

In a case of recognizing another vehicle at the multi-stop intersection MSI, the another vehicle grasping section 73 determines the vehicle type of the another vehicle. The another vehicle grasping section 73 determines the type related to the size, such as a large vehicle AL, a middle vehicle, and a small vehicle As (see FIG. 23), for the another vehicle. The middle vehicle is a vehicle having the same size as the subject vehicle Am. The small vehicle As is a vehicle smaller in size than the subject vehicle Am, such as a motorcycle (two-wheeled vehicle), a cyclist, and an electric kickboard. The another vehicle grasping section 73 determines whether the another vehicle is the large vehicle AL based on the grasped vehicle type of the another vehicle. In a case of recognizing another vehicle that is the large vehicle AL, the another vehicle grasping section 73 acquires detection results of the operation status of the direction indicators 144, the line-of-sight direction of the occupant, the direction of the steering wheel, and the like of the large vehicle AL. The another vehicle grasping section 73 estimates the traveling direction of the large vehicle AL at the multi-stop intersection MSI based on the detection result related to the large vehicle AL.

In a case where the connection road CR is a narrow road, the travel control section 76 changes the travel control according to the vehicle type of another vehicle, and sets a priority order different from a normal priority order based on laws and regulations (for example, the road traffic law and the like). In a case where the another vehicle is the large vehicle AL, the travel control section 76 determines whether the subject vehicle Am is stopped at a position at which the right or left turn (proceeding) of the large vehicle AL is obstructed. In a case where the stop position of the subject vehicle Am is a position at which the right or left turn of the large vehicle AL is not obstructed as in the scene 10 (see FIG. 21), the travel control section 76 performs travel control that prioritizes traveling of the large vehicle AL over the subject vehicle Am. The travel control section 76 causes the subject vehicle Am to wait before a stop line of subject vehicle road JR. As a result, the large vehicle AL can preferentially travel with respect to the subject vehicle Am. The large vehicle AL enters the common region CA from the intersecting road KR before the subject vehicle Am, and starts turning right toward the opposite road TR. The travel control section 76 passes straight through the common region CA and enters the opposite road TR so as to follow the large vehicle AL that has completed right turn.

In a case where the stop position of the subject vehicle Am is a position at which the right or left turn of the large vehicle AL is obstructed as in the scene 11 (see FIG. 21), the travel control section 76 performs travel control in which the priority order of the large vehicle AL and the subject vehicle Am is switched and the traveling of the subject vehicle Am is prioritized over the large vehicle AL. In this case, the device control section 65 notifies the intersection vehicle Ac that the subject vehicle Am enters the common region CA earlier than the large vehicle AL using the out-of-vehicle notification device 45 before the subject vehicle Am starts. The travel control section 76 preferentially starts the subject vehicle Am after the out-of-vehicle notification using the out-of-vehicle notification device 45. As a result, the large vehicle AL can start turning right from the intersecting road KR toward the subject vehicle road JR. The out-of-vehicle notification using the out-of-vehicle notification device 45 may be appropriately omitted. In addition, even in a case where the subject vehicle Am is present at a position at which traveling of the large vehicle AL that is oncoming vehicle Ao (see FIG. 3 and the like) is obstructed, the travel control section 76 performs travel control that gives priority to the subject vehicle Am over large vehicle AL.

### (Scene 12: Scene of Passing Small Vehicle)

In the scene 12 illustrated in FIG. 23, the subject vehicle Am and the oncoming vehicle Ao are approaching the multi-stop intersection MSI. The subject vehicle Am is scheduled to travel straight through the multi-stop intersection MSI. The oncoming vehicle Ao is a small vehicle As such as an electric kickboard, and is scheduled to pass straight through the multi-stop intersection MSI. The scene 12 is a scene where the subject vehicle Am meets a vulnerable road user at the multi-stop intersection MSI.

As in the scenes 10 and 11, the another vehicle grasping section 73 determines the vehicle type of the another vehicle grasped at the multi-stop intersection MSI. Based on the recognized vehicle type of the another vehicle, the another vehicle grasping section 73 determines whether the another vehicle is a small vehicle As, in other words, whether the another vehicle is a vulnerable road user with respect to the subject vehicle Am. The another vehicle grasping section 73 estimates the traveling direction of both As of the small vehicle at the multi-stop intersection MSI based on the detection result related to the recognized small vehicle As.

The road grasping section 74 determines whether the subject vehicle road JR is a narrow road on which the subject vehicle Am and the small vehicle As are allowed to pass each other based on detection information indicating the vehicle width of the small vehicle As recognized by the another vehicle grasping section 73. In a case where the road width of the narrow road is not sufficiently large with respect to each vehicle width of the subject vehicle Am and the small vehicle As, the road grasping section 74 determines that it is difficult to pass each other on the subject vehicle road JR. Further, the road grasping section 74 determines whether the subject vehicle Am and the small vehicle As are allowed to pass each other in the common region CA.

The travel control section 76 moves the subject vehicle Am into the common region CA in a case where the another vehicle is a small vehicle As, it is difficult to pass each other on the subject vehicle road JR, and the subject vehicle Am and the small vehicle As are allowed to pass each other at the multi-stop intersection MSI. In a case where the another vehicle is a small vehicle As, the travel control section 76 performs look-in control to detect a different another vehicle (oncoming vehicle Ao) present behind the small vehicle As. The travel control section 76 causes the subject vehicle Am to enter the common region CA of the multi-stop intersection MSI at a very low speed by the look-in control, and causes the subject vehicle Am to wait (temporarily stop) in the common region CA while to move to the left intersecting road KR. As a result, the small vehicle As and the subject vehicle Am can pass each other, and the small vehicle As passes right of the waiting subject vehicle Am, and proceeds from the common region CA to the subject vehicle road JR. After the small vehicle As exits to the subject vehicle road JR, the travel control section 76 restarts traveling of the subject vehicle Am.

### (Scenes 13 to 15: Scene of Response to Signal of Another Vehicle)

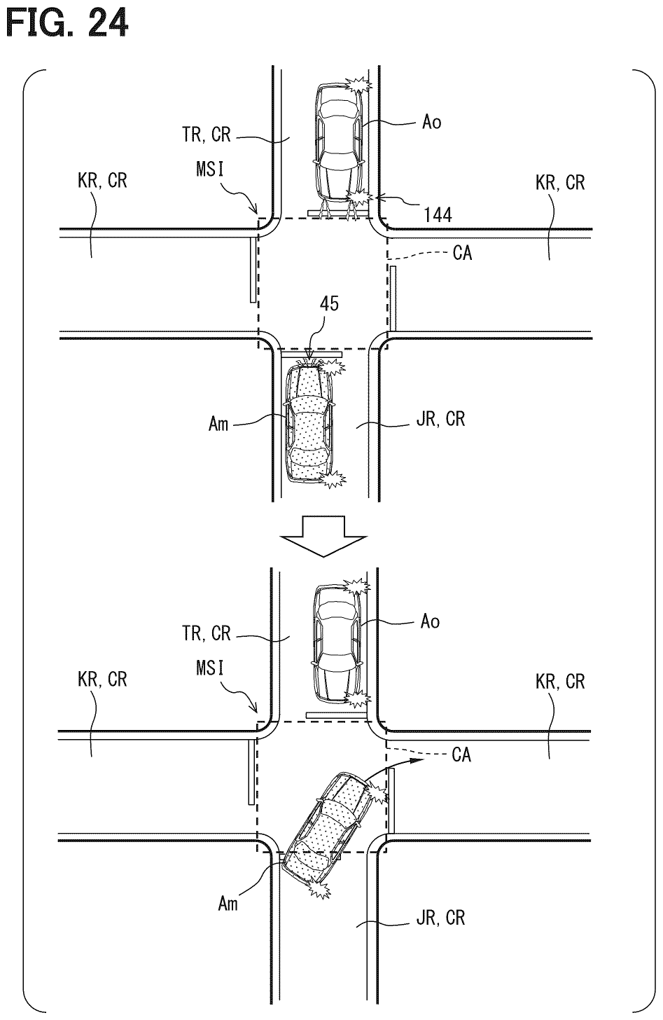

In the scene 13 illustrated in FIG. 24, the subject vehicle Am and the oncoming vehicle Ao are approaching the multi-stop intersection MSI. The subject vehicle Am is scheduled to turn right at the multi-stop intersection MSI. The subject vehicle Am arrives at the multi-stop intersection MSI after the oncoming vehicle Ao. The oncoming vehicle Ao is scheduled to turn left at the multi-stop intersection MSI toward the intersecting road KR that is beyond a right turn of the subject vehicle Am. The oncoming vehicle Ao urges the subject vehicle Am to go ahead by flashing (see the upper part of FIG. 24).

The another vehicle grasping section 73 recognizes an another vehicle signal of the another vehicle indicating to give way to the subject vehicle Am. The another vehicle signal includes, in addition to the flashing in the scene 13, a gesture by the occupant (driver) of the another vehicle, a display by an out-of-vehicle notification device mounted on the another vehicle, an action of sounding a short horn, and the like. Furthermore, in a case where the another vehicle includes a lighting device that displays a light pattern on a road surface, a message drawn by light on the road surface may be used as an another vehicle signal.

In a case where the another vehicle grasping section 73 recognizes the another vehicle signal such as flashing by the another vehicle, the device control section 65 performs out-of-vehicle notification indicating that the another vehicle signal is recognized using the out-of-vehicle notification device 45 visually recognizable from the another vehicle (oncoming vehicle Ao). The device control section 65 causes the out-of-vehicle notification device 45 to display a message mentioning that the subject vehicle Am go ahead, a message expressing gratitude for the another vehicle giving way, and the like.

In a case where the another vehicle signal such as flashing is recognized by the another vehicle grasping section 73 on the connection road CR which is a narrow road, the travel control section 76 changes the priorities of the subject vehicle Am and the another vehicle. Even in a case where the connection road CR is a narrow road, the travel control section 76 performs travel control that prioritizes traveling of the subject vehicle Am over the another vehicle in a case where an another vehicle signal from the another vehicle is recognized. The travel control section 76 starts travel control that prioritizes traveling of the subject vehicle Am after the out-of-vehicle notification to the another vehicle is performed. In the scene 13, after the another vehicle signal from the oncoming vehicle Ao is recognized, the travel control section 76 raises the priority of the subject vehicle Am over the oncoming vehicle Ao and moves the subject vehicle Am toward the intersecting road KR before the oncoming vehicle Ao (see the lower part of FIG. 24).

In a case where the another vehicle signal such as flashing is recognized, the notification request section 72 makes a notification of suggesting a driving-mode switch to the driver in order to cause the subject vehicle Am to preferentially travel. In a case where the driver acquires the control right of the driving operation based on the driving-mode switch proposal notification, the driving operation of moving the subject vehicle Am toward the intersecting road KR before the oncoming vehicle Ao is performed by the driver. In a case where the subject vehicle Am is a remotely operated vehicle, a driving-mode switch in which the remote operation operator of the management center is a driving operator may be performed in the scene 13.

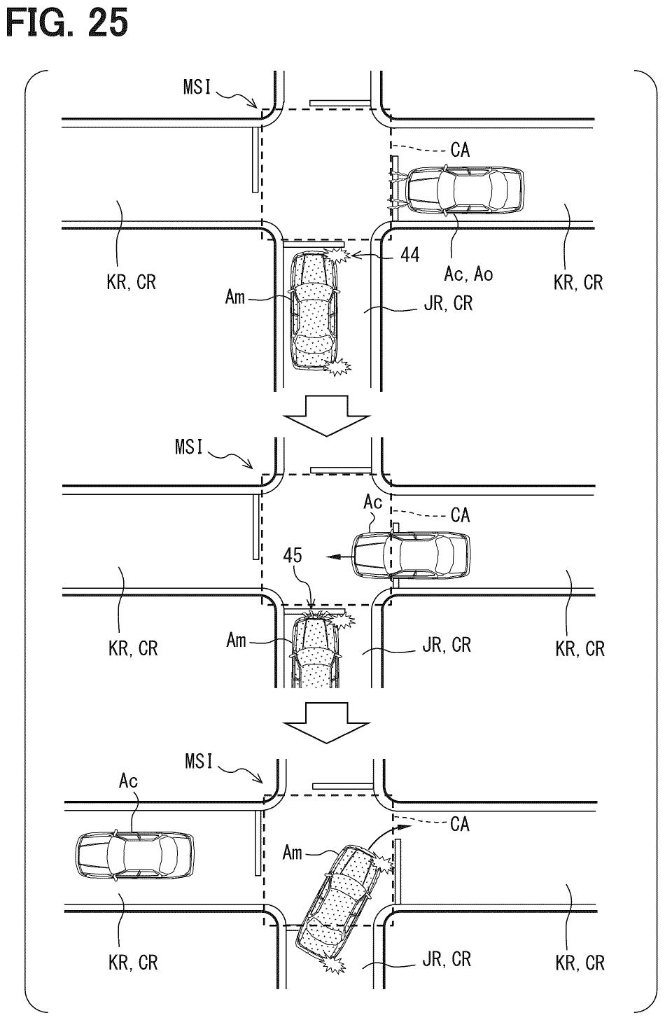

In the scene 14 illustrated in FIG. 25, the subject vehicle Am and the intersection vehicle Ac are approaching the multi-stop intersection MSI. The subject vehicle Am is scheduled to turn right at the multi-stop intersection MSI. The intersection vehicle Ac is traveling on the intersecting road KR, which is beyond a right turn of the subject vehicle Am, and is scheduled to travel straight through the multi-stop intersection MSI. The intersection vehicle Ac urges the subject vehicle Am to go ahead by flashing (see the upper part of FIG. 25). The scene 14 is a scene in which moving of the intersection vehicle Ac is required first for traveling of the subject vehicle Am.

In a case where the another vehicle (the intersection vehicle Ac) that has given the another vehicle signal is at a position at which traveling of the subject vehicle Am is obstructed, the device control section 65 makes the out-of-vehicle notification indicating that the subject vehicle gives way to the another vehicle using the out-of-vehicle notification device 45. The device control section 65 causes the out-of-vehicle notification device 45 to display a message notifying the intersection vehicle Ac that it is difficult for the subject vehicle Am to go ahead, a message notifying the intersection vehicle Ac that it wants the intersection vehicle Ac to go ahead, and the like (see the middle part of FIG. 25). The intersection vehicle Ac enters the common region CA earlier than the subject vehicle Am in response to the out-of-vehicle notification by the out-of-vehicle notification device 45, and passes through the multi-stop intersection MSI.

Even in a case where the another vehicle signal such as flashing is recognized by the another vehicle grasping section 73 on the connection road CR which is a narrow road, the travel control section 76 maintains the priority and gives priority to the traveling of the another vehicle in a case where the another vehicle that has given the another vehicle signal is at a position at which the traveling of the subject vehicle Am is obstructed. In the scene 14, the travel control section 76 causes the subject vehicle Am to wait at the subject vehicle road JR until the intersection vehicle Ac leaves the common region CA. After the intersection vehicle Ac leaves the common region CA, the travel control section 76 moves the subject vehicle Am toward the intersecting road KR (see the lower part of FIG. 25).

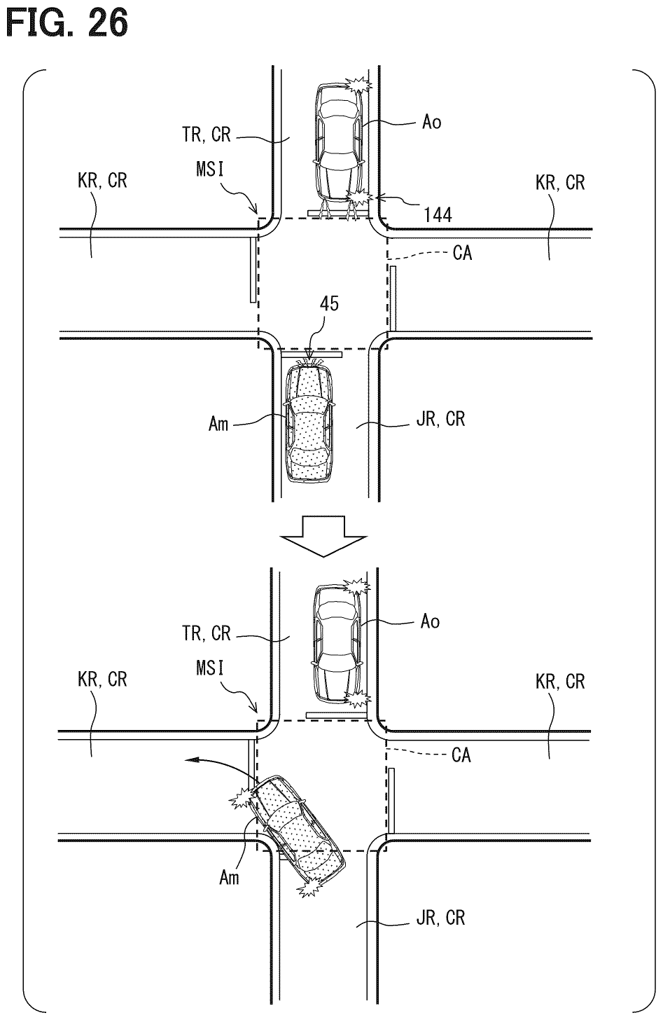

In the scene 15 illustrated in FIG. 26, the subject vehicle Am and the oncoming vehicle Ao are approaching the multi-stop intersection MSI. The subject vehicle Am is scheduled to travel straight through the multi-stop intersection MSI. The oncoming vehicle Ao is traveling on an opposite road TR that is a straight ahead destination of the subject vehicle Am, and is scheduled to turn right at the multi-stop intersection MSI. The oncoming vehicle Ao urges its subject vehicle Am to go ahead by flashing (see the upper part of FIG. 25).

The scene 15 is a scene in which moving of the oncoming vehicle Ao is required first for traveling of the subject vehicle Am. Therefore, the out-of-vehicle notification indicating that the vehicle will give way to the oncoming vehicle Ao is made using the out-of-vehicle notification device 45. However, the oncoming vehicle Ao or the driver of the oncoming vehicle Ao cannot recognize the out-of-vehicle notification, and waits for the subject vehicle Am going ahead on the opposite road TR.

The environment recognition section 62 can change a route to a destination set in the subject vehicle Am in cooperation with the navigation ECU 38. The environment recognition section 62 requests the navigation ECU 38 to change the route to the destination in a case where another vehicle that has given the another vehicle signal continues to wait at the connection road CR, which is the travel destination of the subject vehicle Am at the multi-stop intersection MSI. In the scene 15, the environment recognition section 62 requests the navigation ECU 38 to change the route to a detour route avoiding the opposite road TR where the oncoming vehicle Ao is present. As a result, a change (reroute) from a route going straight through the multi-stop intersection MSI to a route turning left at the multi-stop intersection MSI is performed.

The travel control section 76 resumes the travel control of the subject vehicle Am based on the reroute to the detour route by the cooperation of the environment recognition section 62 and the navigation ECU 38. The travel control section 76 causes the subject vehicle Am to enter the common region CA earlier than the oncoming vehicle Ao according to the detour route after the reroute, and moves the subject vehicle Am toward the intersecting road KR beyond a left turn (see the lower part of FIG. 26).

### (Scene 16: Deadlock Response Scene)

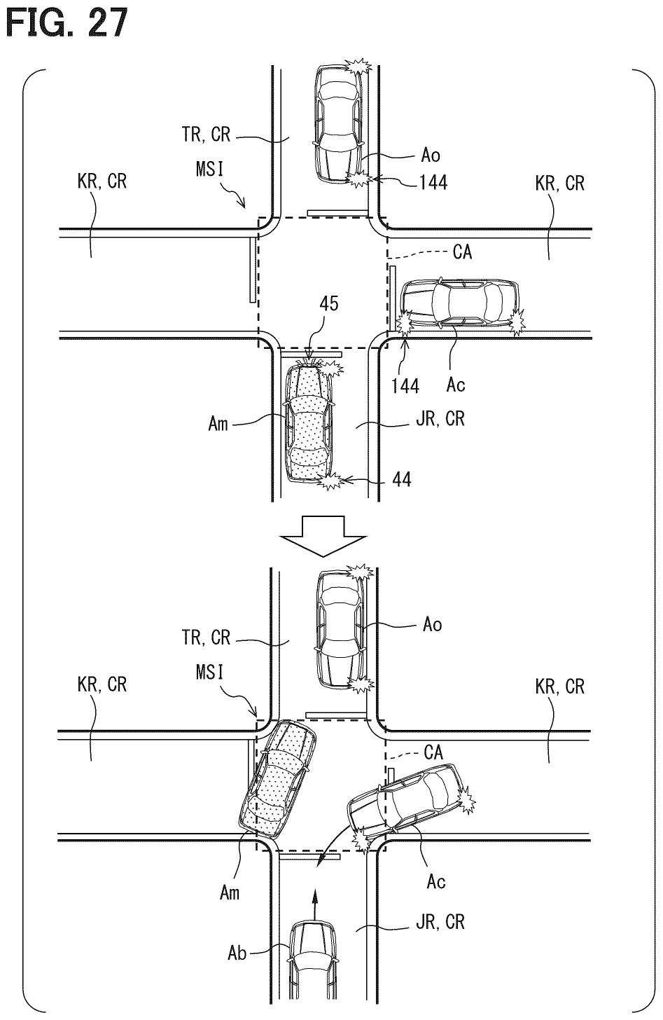

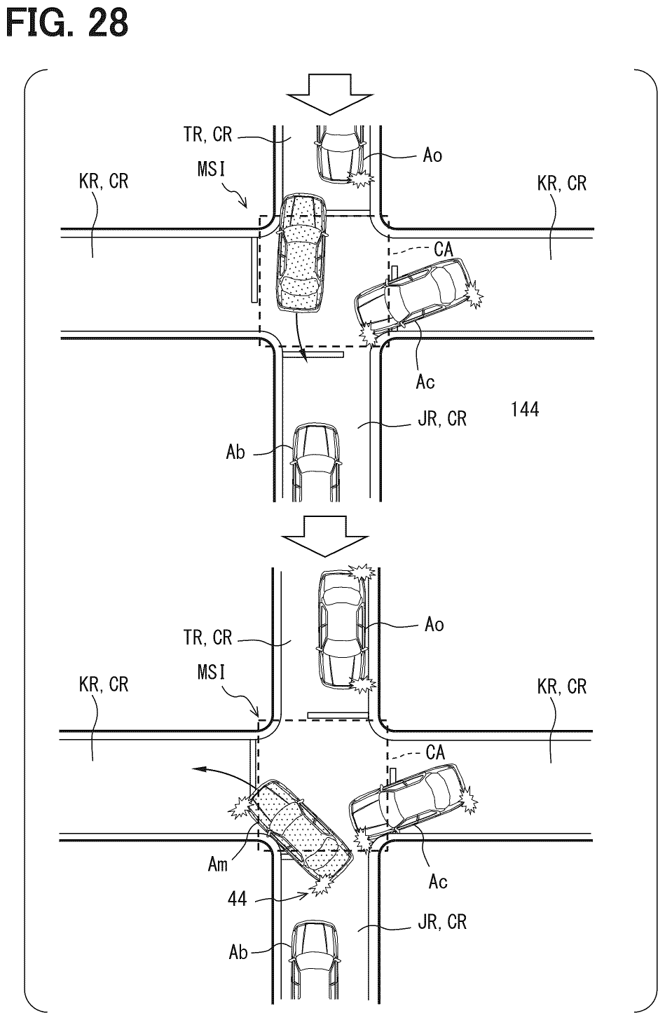

In the scene 16 illustrated in FIGS. 27 and 28, as in the scene 5 of the first embodiment (see FIG. 8 and the like), the subject vehicle Am scheduled to turn right, the oncoming vehicle Ao scheduled to turn left, and the intersection vehicle Ac scheduled to turn left on the subject vehicle road JR are approaching the multi-stop intersection MSI. The another vehicle grasping section 73 estimates the traveling directions of the oncoming vehicle Ao and the intersection vehicle Ac.

In a case where it is estimated that the another vehicle will move to the subject vehicle road JR based on the estimation of the traveling direction of the another vehicle by the another vehicle grasping section 73, the travel control section 76 moves the subject vehicle Am to the multi-stop intersection MSI. The travel control section 76 causes the subject vehicle Am to enter the common region CA after the out-of-vehicle notification by the out-of-vehicle notification device 45 (see the upper part of FIG. 27).

The travel control section 76 causes the front end of the subject vehicle Am to enter the opposite road TR, and then moves the subject vehicle Am backward toward the left intersecting road KR to secure a space where the oncoming vehicle Ao can travel straight right of the subject vehicle Am. After the subject vehicle Am moves into the common region CA, the intersection vehicle Ac starts a left turn from the intersecting road KR toward the subject vehicle road JR (see the lower part of FIG. 27).

In the scene 16, a following vehicle Ab appears on subject vehicle road JR after the intersection vehicle Ac starts turning left. The following vehicle Ab is traveling on the subject vehicle road JR toward the multi-stop, and prevents the intersection vehicle Ac from traveling to the subject vehicle road JR. As described above, the scene 16 is in a deadlock state in which all the vehicles approaching the multi-stop intersection MSI cannot travel in the scheduled traveling direction.

In a case where a deadlock state occurs during standby in the common region CA, the environment recognition section 62 cooperates with the navigation ECU 38 to perform rerouting. Specifically, the environment recognition section 62 requests the navigation ECU 38 to change the setting route to the destination in a case where, after the subject vehicle Am moves to the multi-stop intersection MSI, the following vehicle Ab that obstructs the traveling of the intersection vehicle Ac to the subject vehicle road JR appears on the subject vehicle road JR. In a case where the reroute is performed, the environment recognition section 62 identifies the traveling connection road CR where the subject vehicle Am travels using the latest detection information in order to avoid collision with another vehicle approaching the multi-stop intersection MSI. Look-in control for checking the presence or absence of new another vehicle may be performed by the travel control section 76. The environment recognition section 62 requests the navigation ECU 38 to change to a detour route passing through the connection road CR where the oncoming vehicle Ao and the intersection vehicle Ac are not present. As a result, a change (reroute) from a route turning right at the multi-stop intersection MSI to a route turning left at the multi-stop intersection MSI is performed.

The travel control section 76 resumes the travel control of changing the direction of the subject vehicle Am based on the reroute to the detour route by the cooperation of the environment recognition section 62 and the navigation ECU 38. The travel control section 76 causes the front end of the subject vehicle Am to reenter the opposite road TR, and then causes the subject vehicle Am to move backward diagonally to the right and rearward toward the subject vehicle road JR (see the upper part of FIG. 28). As a result, the subject vehicle Am takes a left turnable posture. The travel control section 76 moves the subject vehicle Am toward the intersecting road KR beyond a left turn (see the lower part of FIG. 28).

In a case where the time of arrival at the destination is delayed by more than the threshold value time due to the change to the detour route, the notification request section 72 notifies the driver of the subject vehicle Am of suggesting the driving-mode switch. The threshold value time may be set to, for example, a certain time (for example, about 10 minutes), or may be set to a predetermined ratio (for example, about 10%) of the remaining arrival time before the reroute. The notification of suggesting the driving-mode switch indicates the reason why the driving-mode switch is proposed.

Here, in a case where a deadlock state occurs, the control switching section 75 may perform a driving-mode switch from the automated driving function to the driver. In addition, in a case where the subject vehicle Am is a remotely operated vehicle, a driving-mode switch in which the remote operation operator of the management center is the driving operator may be performed based on the occurrence of the deadlock state. Also in these cases, the reroute for searching for the detour route is performed, and the post-reroute route is presented to the driver or the remote operation operator.

### Overview of Third Embodiment

The third embodiment described so far exerts effects similar to those of the first embodiment are obtained, and convenience of automated driving at the multi-stop intersection MSI can be secured. In addition, in the third embodiment, in a case where another vehicle is estimated to move to the subject vehicle road JR, the subject vehicle Am moves into the common region CA of the multi-stop intersection MSI. After the subject vehicle Am moves to the multi-stop intersection MSI, in a case where the following vehicle Ab that obstructs the traveling of the another vehicle to the subject vehicle road JR appears on the subject vehicle road JR, the driving-mode switch from the automated driving function to the driver is performed. According to the planned driving-mode switch as described above, the subject vehicle Am can be caused to leave the multi-stop intersection MSI where the deadlock state has occurred.

In addition, in the third embodiment, in a case where the following vehicle Ab that obstructs traveling of another vehicle to the subject vehicle road JR appears on the subject vehicle road JR, the route to the destination set in the subject vehicle Am is changed to a detour route passing through the connection road CR where the another vehicle is not present. According to the execution of the reroute, the subject vehicle Am can be caused to leave the multi-stop intersection MSI where the deadlock state has occurred.

Further, in the third embodiment, in a case where the time of arrival at the destination is delayed by more than the threshold value time due to the change to the detour route, a notification of suggesting a driving-mode switch to the driving operator of the subject vehicle Am is made. As described above, in a case where the driving-mode switch is proposed in a case where the delay is large, the convenience of the automated driving can be further ensured.

In addition, in the third embodiment, a vehicle type of another vehicle is determined. The travel control is changed according to the vehicle type of the another vehicle. According to the above, even in a case where the connection road CR connected to the multi-stop intersection MSI is a narrow road, appropriate travel control according to the vehicle type of other vehicle can be performed.

In the third embodiment, it is determined whether the another vehicle is a large vehicle AL larger in size than the subject vehicle Am as the vehicle type of the another vehicle. In a case where the another vehicle is the large vehicle AL and the stop position of the subject vehicle Am is a position at which the right or left turn of the large vehicle AL is not obstructed, the travel control that prioritizes traveling of the large vehicle AL over the subject vehicle Am is performed. On the other hand, when the another vehicle is the large vehicle AL and the stop position is a position at which the right or left turn of the large vehicle AL is obstructed, the travel control that prioritizes traveling of the subject vehicle Am over the large vehicle AL is performed. According to the above, even in a case where the subject vehicle meets the large vehicle AL at the multi-stop intersection MSI whose connection road CR is a narrow road, it is possible for the subject vehicle to smoothly pass through the multi-stop intersection MSI.

Furthermore, in the third embodiment, it is determined whether the another vehicle is a small vehicle As smaller in size than the subject vehicle Am as the vehicle type of the another vehicle. In a case where the another vehicle is a small vehicle As and the subject vehicle Am and the small vehicle As are allowed to pass each other at the multi-stop intersection MSI, the travel control section 76 causes the subject vehicle Am to wait at the multi-stop intersection MSI. According to the above, even in a case where the subject vehicle meets the small vehicle As at the multi-stop intersection MSI whose connection road CR is a narrow road, it is possible for the subject vehicle to smoothly pass through the multi-stop intersection MSI.

In addition, in the third embodiment, in a case where the another vehicle is a small vehicle As, look-in control for detecting the another vehicle present behind the small vehicle As is performed. According to the above, even in a case where a different another vehicle is present behind the small vehicle As, it is possible to perform travel control assuming that the different another vehicle and the subject vehicle pass each other.

In addition, in the third embodiment, the another vehicle signal of the another vehicle indicating to give way to the subject vehicle Am is recognized. In a case where the another vehicle signal is recognized even though the connection road CR is a narrow road, travel control that prioritizes traveling of the subject vehicle Am over traveling of another vehicle is performed. As described above, it is possible to smoothly pass through the multi-stop intersection MSI by grasping the intention of the another vehicle or the driver thereof.

Further, in the third embodiment, in a case where the another vehicle that has given the another vehicle signal is at a position at which traveling of the subject vehicle Am is obstructed, the out-of-vehicle notification indicating that the subject vehicle Am will give way to the another vehicle is made using the out-of-vehicle notification device 45. According to the above, even in a scene where the another vehicle that has given the another vehicle signal blocks the travel destination of the subject vehicle Am, it is possible to urge the another vehicle to travel and cause the subject vehicle Am to travel along the initially scheduled route.

In addition, in the third embodiment, in a case where the another vehicle that has given the another vehicle signal is at a position at which traveling of the subject vehicle Am is obstructed, the route to the destination set in the subject vehicle Am is changed to a detour route avoiding the connection road CR where the another vehicle is present. According to the above, even in a scene where the another vehicle that has given the another vehicle signal blocks the travel destination of the subject vehicle Am, it is possible to leave the subject vehicle Am from the multi-stop intersection MSI.

In addition, in the third embodiment, in a case where the another vehicle signal is recognized, a notification of suggesting a driving-mode switch to the driving operator of the subject vehicle Am is made. When the driving-mode switch is performed by such a notification, the subject vehicle Am and the another vehicle can smoothly pass through the multi-stop intersection MSI by adjusting the priority order by direct information exchange between the driving operator of the subject vehicle Am and the driving operator of the another vehicle.

Furthermore, in the third embodiment, the out-of-vehicle notification indicating recognition of the another vehicle signal is made using the out-of-vehicle notification device 45. After the out-of-vehicle notification to the another vehicle is made, the travel control that prioritizes traveling of the subject vehicle Am is started. According to the above, the subject vehicle Am going ahead is recognized by the another vehicle or the driving operator of the another vehicle, and then the subject vehicle Am travels to the common region CA. As a result, even in a case where the travel control that prioritizes the traveling of the subject vehicle Am is performed, the subject vehicle Am can smoothly pass through the multi-stop intersection MSI.

In the third embodiment described above, the environment recognition section 62 corresponds to a “route change section”, and the notification request section 72 corresponds to a “notification execution section”.

### OTHER EMBODIMENTS

Although a plurality of embodiments according to the present disclosure has been described above, the present disclosure is not to be construed as being limited to the above embodiments, and can be applied to various embodiments and combinations without departing from the gist of the present disclosure.

In the first modification of the first embodiment, in a case where there are evacuation places both in front of and behind the subject vehicle Am, the travel control section 76 moves the subject vehicle Am to the evacuation place behind so as not to approach another vehicle. According to the first modification, the subject vehicle Am and the another vehicle are allowed to pass each other on a narrow road.

In the second modification of the first embodiment, the execution of the look-in control can be omitted. In the second modification, in a case where the visibility of the intersecting road KR is good or in a case where the situation information about the intersecting road KR can be acquired by communication, the travel control section 76 waits before the stop line without performing the look-in control.

The form of the multi-stop intersection MSI is not limited to the cross path as in the above embodiment. For example, the travel control for the multi-stop intersection MSI may be performed at intersections of various forms such as a multi-way intersection (a six-way intersection or the like), a Y-shaped intersection, a T-shaped intersection, and an annular intersection (roundabout).

In the first and third embodiments, the content of the travel control at the multi-stop intersection MSI is described on the premise of the traffic environment where the vehicle travels on the left side. In addition, in the second embodiment, the content of the travel control at the multi-stop intersection MSI is described on the premise of the traffic environment in which the vehicle travels on the right side. The travel control related to the multi-stop intersection MSI of the present disclosure is applicable to both a traffic environment in which the vehicle travels on the left side and a travel environment in which the vehicle travels on the right side. For example, the control related to the right or left turn is applicable to a traffic environment in which the vehicle travels on the right side and a traffic environment in which the vehicle travels on the left side by switching the right and the left. As described above, the vehicle equipped with the automated driving ECU and the HMI system may be a right-hand drive vehicle or a left-hand drive vehicle. The travel control according to the present disclosure may be appropriately optimized according to the road traffic law of each country and region, the steering wheel position of the vehicle, and the like.

In the third modification of the above embodiment, the driving assistance ECU that performs the driving assistance control at Level 2 is provided separately from the automated driving ECU 50. As in the third modification, the automated driving system including the plurality of in-vehicle ECUs may correspond to an “automated driving control device”.

In the fourth modification of the above embodiment, each function of the automated driving ECU 50 and the HCU 100 is provided by one integrated ECU. In the fourth modification, the integrated ECU corresponds to an “automated driving control device”, and the HCU 100 corresponds to a “notification execution section”.

In the above embodiment, each function provided by the automated driving ECU and the HCU can be provided by software and hardware for executing the software, only software, only hardware, or a combination thereof. Furthermore, in a case where such a function is provided by an electronic circuit as hardware, each function can be provided by a digital circuit including a large number of logic circuits or an analog circuit.

Each processing section of the above-described embodiment has a configuration including at least one arithmetic core such as a central processing unit (CPU) and a graphics processing unit (GPU). The processing section may further include a field-programmable gate array (FPGA), a neural network processing unit (NPU), an IP core having another dedicated function, and the like. The processing section is not limited to the configuration individually mounted on the printed circuit board. The processing section may be implemented in an application specific integrated circuit (ASIC), a system on chip (SoC), a chiplet integrated body, an FPGA, or the like.

The form of the storage medium (continuous tangible computer reading medium, non-transitory tangible storage medium) that stores various programs and the like may be appropriately changed. Furthermore, the storage medium is not limited to the configuration provided on the circuit board, and may be provided in the form of a memory card or the like, inserted into the slot portion, and electrically connected to a control circuit such as an automated driving ECU or an HCU. Furthermore, the storage medium may be an optical disk, a hard disk drive, a solid state drive, or the like that is a copy source or a distribution source of a program to the automated driving ECU or the HCU.

The vehicle on which the automated driving ECU and the HMI system are mounted is not limited to a general private car, and may be a vehicle for a rental car, a vehicle for a manned taxi, a vehicle for ride-sharing, a cargo vehicle, a bus, or the like.

The control unit and its methods described in the present disclosure may be implemented by a dedicated computer comprising a processor programmed to execute one or more functions embodied by a computer program. Alternatively, the apparatus and methods described in the present disclosure may be implemented by dedicated hardware logic circuits. Furthermore, the apparatus and methods described in the present disclosure may be implemented by one or more dedicated computers configured by a combination of a processor that executes a computer program and one or more hardware logic circuits. In addition, the computer program may be stored as instructions executable by a computer on a non-transitory, computer-readable tangible recording medium.

### (Technical Idea 40)

An automated driving control device enables traveling of a subject vehicle by an automated driving function. The automated driving control device including a road determination section that determines whether a preceding intersection through which the subject vehicle traveling by autonomous travel control in which a driver is not obliged to monitor surroundings is scheduled to pass is a multi-stop intersection, and a control switching section that permits continuation of traveling by the autonomous travel control in a case where the preceding intersection is not the multi-stop intersection, and terminates the autonomous travel control in a case where the preceding intersection is the multi-stop intersection.

### (Technical Idea 41)

In the automated driving control device according to Technical idea 40, the control switching section switches a control state of the subject vehicle to manual driving by a driver in a case where other vehicles scheduled to enter the multi-stop intersection are temporarily stopped at two or more of connection roads connected to the multi-stop intersection.

### (Technical Idea 42)

In the automated driving control device according to Technical idea 40 or 41, the control switching section switches a control state of the subject vehicle to manual driving by a driver in a case where another vehicle scheduled to enter the multi-stop intersection does not start for a predetermined time or more after temporarily stopping together with the subject vehicle.

### (Technical Idea 43)

The automated driving control device according to any one of Technical ideas 40 to 42 further includes a travel control section that performs control of returning a direction of a steering wheel of the subject vehicle to a predetermined initial position in a case where a driving-mode switch to manual driving by a driver is performed.

### (Technical Idea 44)

In the automated driving control device according to Technical idea 43, the travel control section performs control of returning a direction of the steering wheel to the initial position in a case where the subject vehicle is scheduled to turn right or left at the multi-stop intersection.

What is claimed is:

1. An automated driving control device that enables traveling of a subject vehicle by an automated driving function, the automated driving control device comprising
at least one of (i) a circuit and (ii) a processor with a memory storing computer program code executable by the processor, the at least one of the circuit and the processor configured to cause the automated driving control device to implement:
an another vehicle determination section configured to determine a priority relationship between the subject vehicle and another vehicle at a multi-stop intersection;
a road determination section configured to determine whether a connection road connected to the multi-stop intersection is a narrow road on which it is difficult for the subject vehicle and the another vehicle to pass each other; and
a travel control section configured to perform, at the multi-stop intersection, a travel control of the subject vehicle according to the priority relationship in a case where the connection road is not the narrow road, and performs a travel control that gives priority to traveling of the another vehicle in a case where the connection road is the narrow road.

2. The automated driving control device according to claim 1, wherein
the another vehicle determination section estimates a traveling direction of the another vehicle at the multi-stop intersection, and
in a case where the subject vehicle obstructs traveling of the another vehicle, the travel control section moves the subject vehicle to a standby position where the subject vehicle does not obstruct traveling of the another vehicle.

3. The automated driving control device according to claim 1, wherein:
the another vehicle determination section estimates a traveling direction of the another vehicle at the multi-stop intersection; and
the travel control section
causes the subject vehicle to wait on a subject vehicle road in a case where an oncoming vehicle, which is the another vehicle, is estimated to move to the connection road different from the subject vehicle road where the subject vehicle is located, and
causes the subject vehicle to wait at the multi-stop intersection in a case where the oncoming vehicle is estimated to move to the subject vehicle road.

4. The automated driving control device according to claim 1, wherein
the another vehicle determination section estimates a traveling direction of the another vehicle at the multi-stop intersection, and
in a case the another vehicle located on an intersecting road on which the subject vehicle is scheduled to turn right or left is estimated to move to the subject vehicle road where the subject vehicle is located, the travel control section causes the subject vehicle to leave the subject vehicle road and causes the subject vehicle to enter the intersecting road after the another vehicle moves to the subject vehicle road.

5. The automated driving control device according to claim 1, wherein
the another vehicle determination section estimates a timing at which the another vehicle reaches the multi-stop intersection, and
in a case where the connection road is the narrow road, the travel control section causes the another vehicle estimated to arrive at the multi-stop intersection within a predetermined time to preferentially travel through the multi-stop intersection even when the subject vehicle arrives at the multi-stop intersection earlier than the another vehicle.

6. The automated driving control device according to claim 1, wherein
in a case where a standby state for giving priority to the another vehicle continues for more than a predetermined time, the travel control section terminates the standby state.

7. The automated driving control device according to claim 1, wherein
in a case where the another vehicle travels in a scheduled traveling direction of the subject vehicle, the travel control section starts the subject vehicle so that the subject vehicle follows the another vehicle.

8. The automated driving control device according to claim 1, wherein
the at least one of the circuit and the processor is further configured to cause the drowsiness sign notification device to implement
an out-of-vehicle notification control section configured to notify an outside of the subject vehicle that the subject vehicle is traveling by the automated driving function at the multi-stop intersection using an out-of-vehicle notification device.

9. The automated driving control device according to claim 1, wherein
in a case where the connection road is the narrow road, the travel control section performs look-in control of causing the subject vehicle to temporarily stop and then enter the multi-stop intersection to detect an intersection vehicle, which is the another vehicle in a left-right direction.

10. The automated driving control device according to claim 1, wherein
in a case where the another vehicle enters a subject vehicle road on which the subject vehicle waits, the road determination section determines whether there is an evacuation place where the subject vehicle is allowed to be evacuated in front of or behind the subject vehicle, and
the travel control section moves the subject vehicle to the evacuation place in a case where there is the evacuation place.

11. The automated driving control device according to claim 1, wherein
the another vehicle determination section estimates a traveling direction of the another vehicle at the multi-stop intersection,
the travel control section moves the subject vehicle to the multi-stop intersection in a case where it is estimated that the another vehicle moves to a subject vehicle road where the subject vehicle is located, and
the automated driving control device further comprises a control switching section configured to execute a driving-mode switch from the automated driving function to a driving operator in a case where a following vehicle that obstructs traveling of the another vehicle to the subject vehicle road appears on the subject vehicle road after the subject vehicle moves to the multi-stop intersection.

12. The automated driving control device according to claim 1, wherein
the another vehicle determination section estimates a traveling direction of the another vehicle at the multi-stop intersection,
the travel control section moves the subject vehicle to the multi-stop intersection in a case where it is estimated that the another vehicle moves to a subject vehicle road where the subject vehicle is located, and
the automated driving control device further comprises a route change section configured to change a route to a destination set in the subject vehicle to a detour route passing through the connection road where the another vehicle is not present in a case where a following vehicle that obstructs traveling of the another vehicle to the subject vehicle road appears on the subject vehicle road after the subject vehicle moves to the multi-stop intersection.

13. The automated driving control device according to claim 1, wherein
the another vehicle determination section determines a vehicle type of the another vehicle, and
the travel control section changes the travel control according to the vehicle type of the another vehicle.

14. The automated driving control device according to claim 1, wherein
the another vehicle determination section recognizes an another vehicle signal, of the another vehicle, indicating to give way to the subject vehicle, and
in a case where the another vehicle signal is recognized even in a case where the connection road is the narrow road, the travel control section performs the travel control of prioritizing traveling of the subject vehicle over traveling of the another vehicle.

15. The automated driving control device according to claim 1, wherein
the another vehicle determination section estimates a traveling direction of the another vehicle at the multi-stop intersection, and
in a case where the subject vehicle starts moving in a direction different from a traveling direction estimated by the another vehicle while the subject vehicle is moving, the travel control section brings the subject vehicle into a stop preparation state in which the subject vehicle is capable of being immediately stopped.

16. The automated driving control device according to claim 1, wherein
the another vehicle determination section grasps, as a risk vehicle, the another vehicle that starts a right or left turn without operating a direction indicator, and
in a case where the risk vehicle is grasped while the subject vehicle is moving, the travel control section brings the subject vehicle into a stop preparation state where the subject vehicle is capable of being immediately stopped.

17. The automated driving control device according to claim 1, wherein
the another vehicle determination section acquires, by communication, another vehicle information indicating a position and a traveling direction of the another vehicle traveling by the automated driving function, and
in a case where the another vehicle information is acquired before the multi-stop intersection, the travel control section starts the travel control that gives priority to traveling of the another vehicle on the connection road before the multi-stop intersection.

18. A non-transitory computer readable storage medium storing an automated driving control program that enables traveling of a subject vehicle by an automated driving function, the automated driving control program for causing at least one processing section to execute:
determining a priority relationship between the subject vehicle and another vehicle at a multi-stop intersection;
determining whether a connection road connected to the multi-stop intersection is a narrow road on which it is difficult for the subject vehicle and the another vehicle to pass each other; and
performing, at the multi-stop intersection, a travel control of the subject vehicle according to the priority relationship in a case where the connection road is not the narrow road, and performing the travel control that gives priority to traveling of the another vehicle in a case where the connection road is the narrow road.

19. An automated driving control method that enables traveling of a subject vehicle by an automated driving function, the method executed by at least one processing section, the method comprising:
determining a priority relationship between the subject vehicle and another vehicle at a multi-stop intersection;
determining whether a connection road connected to the multi-stop intersection is a narrow road on which it is difficult for the subject vehicle and the another vehicle to pass each other; and
performing, at the multi-stop intersection, a travel control of the subject vehicle according to the priority relationship in a case where the connection road is not the narrow road, and performing the travel control that gives priority to traveling of the another vehicle in a case where the connection road is the narrow road.
